(19) United States
(12) Patent Application Publication
(10) Pub. No.: US 2005/0155047 A1
(43) Pub. Date: Jul. 14, 2005

(54) Information reproducing device

(75) Inventors: Tsuyoshi Kakuta, Kurume-shi (JP); Nobuo Jikuya, Chikushino-shi (JP); Yoshitatsu Kajiwara, Kasuga-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 11/031,533

(22) Filed: Jan. 10, 2005

(30) Foreign Application Priority Data
Jan. 9, 2004 (JP) 2004-003869
Jun. 29, 2004 (JP) 2004-190692
Jun. 30, 2004 (JP) 2004-193666

(51) Int. Cl. G11B 17/04; G11B 21/08; G11B 7/085

(52) U.S. Cl. 720/619

(57) ABSTRACT

There is provided an information reproducing device capable of performing replacement of a medium with good operability. The information reproducing device includes a main body, a connector unit and a medium inserting unit of the main body, a lifting unit which is provided to be freely raised or lowered, a reproducing unit for reproducing at least information from the medium, an elastic member for applying a biasing force to the lifting unit and the main body in a direction that the lifting unit and the main body are pulled away from each other, a locking member for locking the main body and the lifting unit, and a regulating member for regulating the traveling distance between the main body and the lifting unit. In a state in which the main body and the lifting unit are locked by the locking member, the medium inserting unit is closed, and when the locking member is unlocked, the lifting unit is separated from the main body by the elastic member, and the medium inserting unit is opened.

### BACKGROUND OF THE INVENTION

1. Field of the Invention

The present invention relates to an information reproducing device capable of reproducing at least information in which the device can be connected to a portable terminal apparatus such as a portable information apparatus, a cellphone and a portable game machine and to a personal computer, etc.

2. Description of the Related Art

With the progress of digital technologies, different kinds of data to be processed are rapidly increasing. For this reason, data recordable and reproducible media suitable to various uses are being developed. As a recordable and reproducible medium for a computer or the like, a hard disk, an optical disk, a semiconductor memory, or the like is exemplified. In particular, a recordable and reproducible medium using an optical disk is widely used due to its economical cost per capacity at the time of the replacement of the optical disk and its random accessibility. Further, in the case of a read only memory (ROM), it is advantageous in that the disk can be easily manufactured.

On the other hand, an apparatus such as a personal computer or the like using the recordable and reproducible medium which can be used outdoors as well as indoors is demanded. For example, a portable personal computer such as a laptop computer or the like, a portable apparatus such as a personal digital assistant (PDA), a cellphone, a portable game machine, a digital camera, or the like is exemplified. In this case, if the storage capacity of a data recording device provided in a data recordable medium is small, a semiconductor memory is generally used. The semiconductor memory is advantageous in that is has low power consumption, high data transfer rate and durable resistance against breakdown because it has no mechanism section. However, the semiconductor memory is not suitable for a large-capacity recording medium because it is high in cost per storage capacity.

In contrast, hard disk drives (HDD) which are widely used as the data recording device are suitable for a high-capacity recordable medium because the data transmission rate is high and the cost per storage capacity is low, although they are inferior to the semiconductor memory.

At present, a portable apparatus such as the PDA or the like is provided with a standard connector using a card type medium called a Compact Flash (Registered Trademark) card (hereinafter, referred to as a CF card). In this case, the data storage capacity can be increased by connecting the connector to the semiconductor memory card or the hard disk drive (HDD) (generally referred to as a micro drive) which is used as a memory. Further, for other uses, the connector may be connected to a wireless unit, a local area network (LAN) card, a global positioning system (GPS) card, a digital camera unit, or a barcode unit, thereby expanding the uses of the portable apparatus.

Japanese Patent Laid-Open No. 10-97781 discloses a compact optical disk drive provided with a tray which is mounted on an main body of the optical disk drive so as to be freely opened or closed and which accommodates a cartridge having an optical disk built therein.

However, in an information reproducing device disclosed in Japanese Patent Laid-Open No. 10-97781, when the recording medium is replaced, the information reproducing device must be removed from the computer, which results in a problem in that its operability becomes poor.

Further, a compact hard disk and a semiconductor memory are used as the memory for the portable terminal. However, when a user intends to view an image, he/she has no choice but to transmit data from a personal computer or other video players and to view the data using a display unit on the portable terminal.

### SUMMARY OF THE INVENTION

The present invention has been made to solve the above conventional problems. Accordingly, it is an object of the present invention to provide an information reproducing device capable of replacing a recording medium with good operability.

The present invention has been made to solve the above problems. Accordingly, it is an object of the present invention to provide an information reproducing device capable of replacing a recording medium with good operability in a state in which the information reproducing device is connected to a terminal apparatus.

The present invention has been made to solve the above problems. Accordingly, it is an object of the present invention to provide an information reproducing device capable of reproducing and displaying information on an optical disk medium with high distribution capability on a portable terminal.

In order to solve the above object, the present invention provides an information reproducing device comprising: a main body; a connector unit provided in the main body for establishing an electrical connection with other apparatus; a medium inserting unit provided in the main body; a lifting unit which is provided to be freely raised or lowered with respect to the main body and which opens and closes the medium inserting unit; a reproducing unit held in the lifting unit for reproducing at least information from the medium; an elastic member for applying a biasing force to the lifting unit and the main body in a direction that the lifting unit and the main body are pulled away from each other; a locking member for locking the main body and the lifting unit; and a regulating member for regulating the traveling distance between the main body and the lifting unit. In a state in which the main body and the lifting unit are locked by the locking member, the medium inserting unit is closed, and when the locking member is unlocked, the lifting unit is separated from the main body by the elastic member, and the medium inserting unit is opened.

According to the above construction of the present invention, while the medium inserting unit can be opened or closed by raising or lowering the lifting unit. Thus, in a state in which the connector unit is inserted into other apparatus, a medium can be replaced. As a result, the operability can be improved.

In order to solve the above-mentioned problem, there is provided an information reproducing device comprising a main body, a connector unit provided in the main body for establishing an electrical connection with a terminal apparatus, a medium inserting unit provided in the main body for inserting a medium, a lifting unit which is provided so as to be freely raised or lowered with a cantilever mechanism having its one axis fixed to the main body and which opens and closes the medium inserting unit, and a reproducing unit held in the lifting unit for reproducing at least information from the medium. While the information reproducing device is connected to the terminal apparatus which controls the information reproducing device, the medium inserting unit is provided at a position where the medium can be replaced from a direction opposite to the direction that the information recording device is connected to the terminal apparatus.

According to the present invention, while the connector unit is connected to the terminal apparatus, the medium inserting unit can be opened or closed by raising or lowering the lifting unit. Thus, in a state in which the information reproducing device is connected to the terminal apparatus, the medium can be replaced. Therefore, the operability can be improved.

In order to solve the above object, the present invention provides an information reproducing device comprising an insertion slot into which an optical disk is inserted, a lifting unit which opens and closes the insertion slot, a reproducing unit held in the lifting unit for reproducing at least information from the optical disk, an electronic board which converts an optical signal output from the reproducing unit into an electrical signal, and a connector unit which establishes an electrical connection with other apparatus.

According to the present invention, since information on a distributed content medium can be easily viewed using a display unit of a portable terminal, it is possible to realize an information reproducing device which allows compactness and simple operation without transmitting data from a personal computer or other video players. Also, since a distributed medium can be directly reproduced, the copyright thereof can be effectively protected.

### BRIEF DESCRIPTION OF THE DRAWINGS

FIG. 1 is a perspective view showing an information reproducing device according to an embodiment of the present invention;

FIG. 2 is a partially enlarged view of the information reproducing device according to the embodiment of the present invention;

FIG. 3 is a partially enlarged view of the information reproducing device according to the embodiment of the present invention;

FIG. 4 is a partially enlarged view of the information reproducing device according to the embodiment of the present invention;

FIG. 5 is a perspective view showing the information reproducing device according to the embodiment of the present invention;

FIG. 6 is a perspective view of the information reproducing device according to the embodiment of the present invention;

FIG. 7 is a perspective view showing an optical cartridge used for the information reproducing device according to the embodiment of the present invention;

FIG. 8 is a perspective view showing the information reproducing device according to the embodiment of the present invention;

FIG. 9 is a perspective view showing the information reproducing device according to the present invention;

FIG. 10 shows the operation of the information reproducing device according to the embodiment of the present invention;

FIG. 11 shows the operation of the information reproducing device according to the embodiment of the present invention;

FIG. 12 shows the operation of the information reproducing device according to the embodiment of the present invention;

FIG. 13 shows the operation of the information reproducing device according to the embodiment of the present invention;

FIG. 14 shows the operation of the information reproducing device according to the embodiment of the present invention;

FIG. 15 shows the operation of the information reproducing device according to the embodiment of the present invention;

FIG. 16 shows the operation of the information reproducing device according to the embodiment of the present invention;

FIG. 17 shows the operation of the information reproducing device according to the embodiment of the present invention;

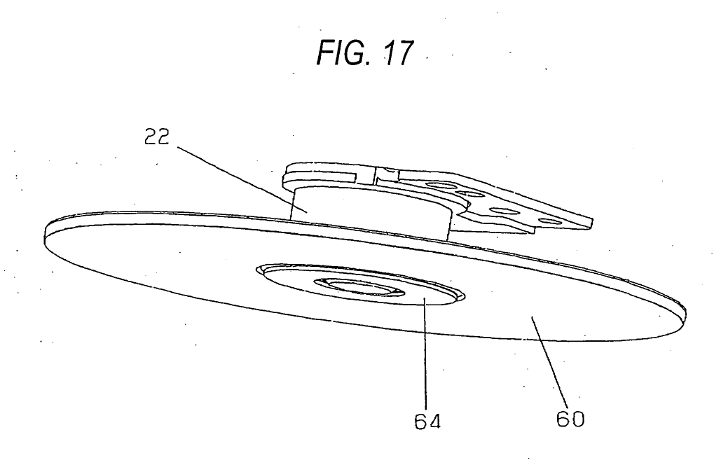

FIG. 18 shows the operation of the information reproducing device according to the embodiment of the present invention;

FIG. 19 shows the operation of the information reproducing device according to the embodiment of the present invention;

FIG. 20 shows the operation of the information reproducing device according to the embodiment of the present invention;

FIG. 21 shows the operation of the information reproducing device according to the embodiment of the present invention;

FIG. 22 shows the operation of the information reproducing device according to the embodiment of the present invention;

FIG. 23 is a side perspective view of an information reproducing device according to an embodiment of the present invention;

FIG. 24 is a front perspective view of the information reproducing device according to the embodiment of the present invention;

FIG. 25 is a perspective view showing a structure of a recording and reproducing mechanism main body;

FIG. 26 shows a state in which a recording and reproducing mechanism section is raised or lowered;

FIG. 27 shows a state in which the recording and reproducing mechanism section is raised;

FIG. 28 shows a first modification of the embodiment of the present invention;

FIG. 29 shows a state in which an optical disk cartridge is inserted, in the first modification of the embodiment of the present invention;

FIG. 30 shows a second modification of the embodiment of the present invention;

FIG. 31 shows a third modification of the embodiment of the present invention;

FIG. 32 is a perspective view showing a structure of a recording and reproducing mechanism main body of an information reproducing device according to another embodiment of the present invention;

FIG. 33 shows a state in which the recording and reproducing mechanism section raised or lowered;

FIG. 34 is a perspective view showing a state in which the recording and reproducing mechanism section is raised;

FIG. 35 shows a first modification according to another embodiment of the present invention;

FIG. 36 shows a second modification according to another embodiment of the present invention;

FIG. 37 is a perspective view showing an information reproducing device according to an embodiment of the present invention;

FIG. 38 is a partially enlarged view of the information reproducing device according to the embodiment of the present invention;

FIG. 39 shows a state in which covers are removed from a recording and reproducing mechanism section in the information reproducing device according to the embodiment of the present invention;

FIG. 40 shows a state in which a recording and reproducing mechanism section internal circuit board is removed from the recording and reproducing mechanism section in the information reproducing device according to the embodiment of the present invention;

FIG. 41 is a perspective view showing a top surface of a connector section in the information reproducing device according to the embodiment of the present invention;

FIG. 42 is a perspective view showing a bottom surface of the connector section in the information reproducing device according to the embodiment of the present invention;

FIG. 43 shows an optical disc cartridge according to the embodiment of the present invention;

FIG. 44 shows the operation of the information reproducing device according to the embodiment of the present invention;

FIG. 45 shows the operation of the information reproducing device according to the embodiment of the present invention; and

FIG. 46 shows a construction of a board in the information reproducing device according to the embodiment of the present invention.

### DESCRIPTION OF THE PREFERRED EMBODIMENTS

Hereinafter, an embodiment of the present invention will be described with reference to the accompanying drawings.

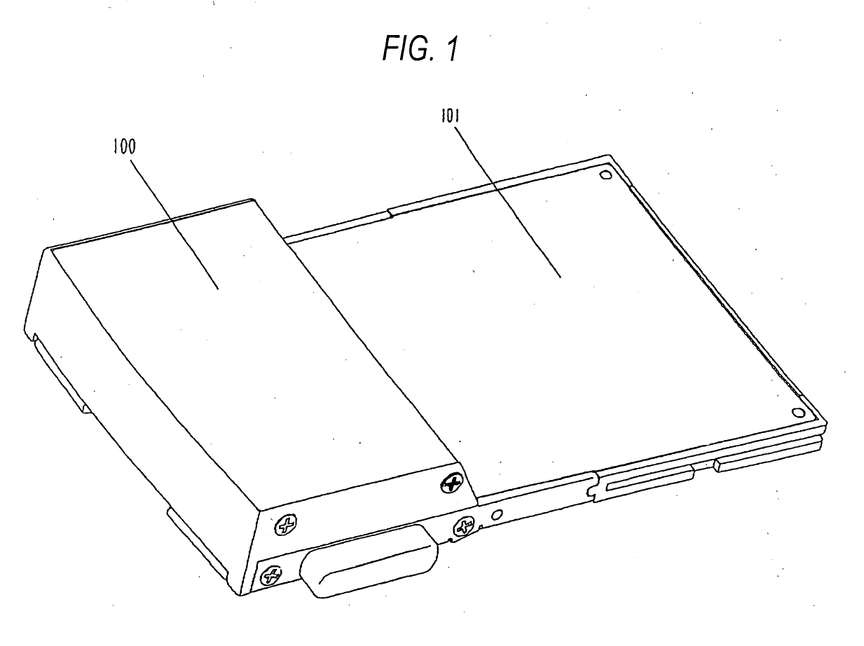

As shown in FIG. 1, an information reproducing device according to the present embodiment generally comprises a recording and reproducing mechanism section 100 having a recording and reproducing device member (which either records information on an optical disk or reproduces information from the optical disk) of the optical disk, and an CF card standard mechanism section 101 having a connector and a main body corresponding to a CF card standard.

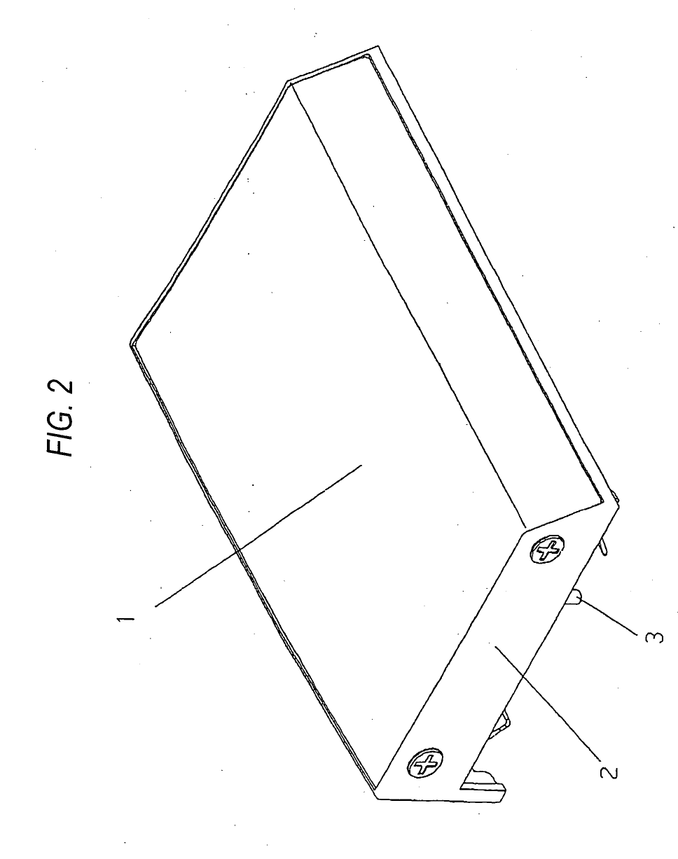

First, the recording and reproducing mechanism section 100 will be described with reference to FIG. 2. As shown in FIG. 2, the reference numerals 1 and 2 indicate covers which cover the recording and reproducing mechanism section 100, respectively. The cover 2 constitutes sidewalls, and the cover 1 constitutes a top surface. That is, the recording and reproducing mechanism section 100 is covered with the covers 1 and 2. The covers 1 and 2 may be made of either the same material or materials different from each other. In the best mode, the cover is made of a resinous material and the cover 1 is made of a metallic material, so that effects such as an improved heat dissipating property and electronic noise leakage prevention of the recording and reproducing mechanism section 100 can be obtained. Naturally, materials for the covers 1 and 2 can be appropriately selected to solve a heat problem, a noise problem, and a problem of mechanical rigidity.

The reference numeral 3 indicates a vertical guide member made of a material, such as metal, for lifting the recording and reproducing mechanism section 100 in a vertical direction.

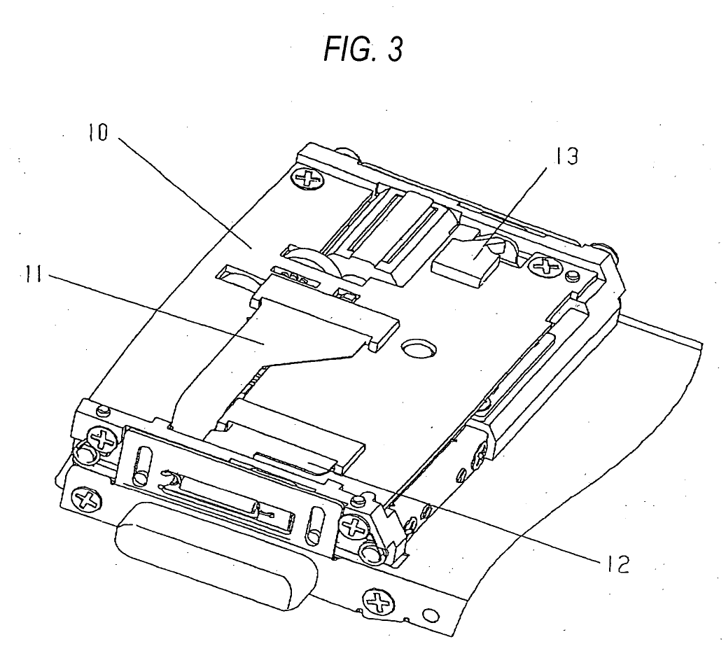

FIG. 3 shows a state in which the covers 1 and 2 are removed from the recording and reproducing mechanism section 100. In FIG. 3, the reference numeral 10 indicate a recording and reproducing mechanism section internal circuit board which is provided within the recording and reproducing mechanism section 100, the reference numeral 11 indicates a flexible printed circuit (hereinafter, referred to as FPC) for an optical pickup signal which transmits and receives a signal read from the optical disk, the reference numeral 12 indicate an inter-board FPC which transmits a signal to or receives a signal from a circuit board within the CF card standard mechanism section 101, and the reference numeral 13 indicate an electronic switch which is mounted on the recording and reproducing mechanism section internal circuit board 10 and which is turned on or off by vertical movement of the recording and reproducing mechanism section 100.

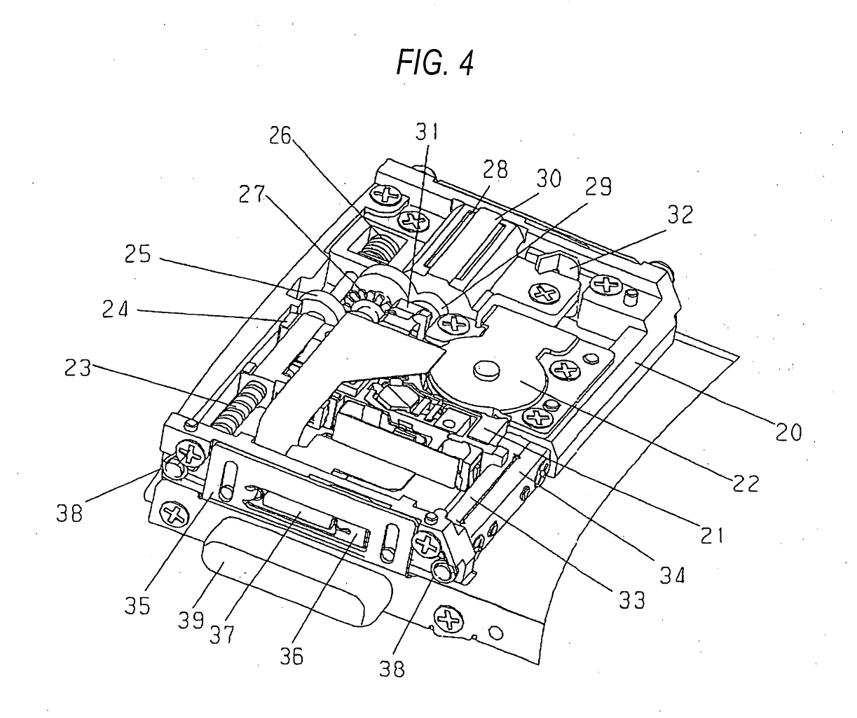

FIG. 4 shows a state in which the recording and reproducing mechanism section internal circuit board 10 is removed from the recording and reproducing mechanism section 100 in FIG. 3. The reference numeral 20 indicates a recording and reproducing mechanism main body serving as a base of the recording and reproducing mechanism section 100, the reference numeral 21 indicates an optical pickup module which records information to and reproduces information from the optical disk, the reference numeral 22 indicates a spindle motor which serves as a power source for rotating the optical disk, the reference numeral 23 indicates a lead screw shaft which is threaded to move the optical pickup module 21 to inner and outer circumferential positions of the optical disk, the reference numeral 24 indicates a rack leaf spring which transmits power from the lead screw shaft 23 to the optical pickup module 21 and which holds the FPC incorporated into the optical pickup module 21, the reference numeral 25 indicates a lead screw shaft gear fixed to the lead screw shaft 23, the reference numeral 26 indicates a lead screw shaft pressing spring which presses the lead screw shaft 23 in an arbitrary direction, the reference numeral 27 indicates an intermediate gear having gears on both sides thereof and a circular shielding plate which is provided with a slit at its central portion, the reference numeral 28 indicates a feed motor serving as a power source which rotates the lead screw shaft 23, the reference numeral 29 indicates a motor gear mounted to a rotating shaft of the feed motor 28, the reference numeral 30 indicates a motor fixing member for holding the feed motor 28, the reference numeral 31 indicates a photointerrupter for measuring the number of revolutions of the intermediate gear so as to measure the number of revolutions of the feed motor 28, the reference numeral 32 indicates a recording and reproducing mechanism section vertical movement sensing lever for sensing the vertical movement of the recording and reproducing mechanism section 100 when an optical disk cartridge having the optical disk incorporated thereinto is attached to or detached from the optical disk drive of the present invention, the reference numeral 33 indicates a guide shaft which regulates and guides the movement of the optical pickup module 21 to inner and outer circumferential positions of the optical disk, the reference numeral 34 indicates a guide shaft fixing member for fixing the guide shaft 33 to the recording and reproducing mechanism main body 20, the reference numeral 35 indicates metallic lateral guide members which regulate the vertical movement of the recording and reproducing mechanism main body 20 and are mounted on both sides of the CF card standard mechanism section 101, the reference numeral 36 indicates claw-shaped lateral mooring members which are mounted on both sides of the CF card standard mechanism section 101 and which moor the recording and reproducing mechanism main body 20 to the CF card standard mechanism section 101, the reference numeral 37 indicates lateral mooring biasing springs for applying a biasing force in an arbitrary direction to the lateral mooring member 36 respectively, the reference numeral 38 indicates recording and reproducing mechanism main body lifting springs including a torsion spring which lift the recording and reproducing mechanism main body 20, when the optical disk cartridge having the optical disk incorporated therein is attached to or detached from the optical disk drive, and the reference numeral 39 indicate slide buttons fixed to the lateral mooring members 36.

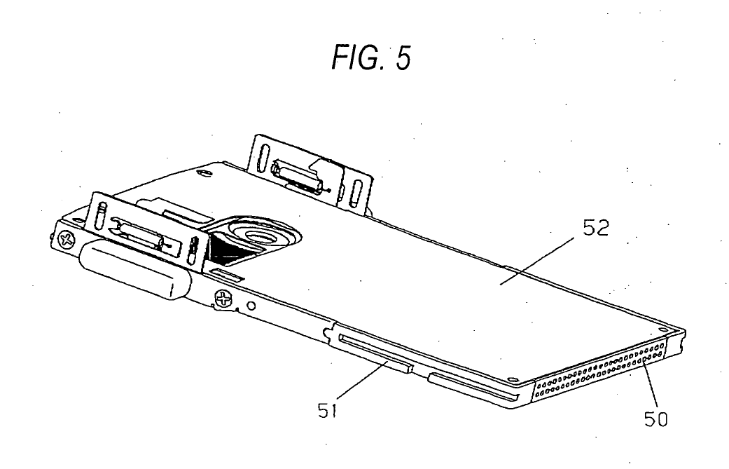

Next, the CF card standard mechanism section 101 having a connector and a main body corresponding to the CF card standard will be described with reference to FIG. 5. The reference numeral 50 indicates a CF card standard connector, and the reference numeral 51 indicates a CF card standard mechanism section frame, and the reference numeral 52 indicates a metallic top cover which covers a top surface of the CF card standard mechanism section frame 51.

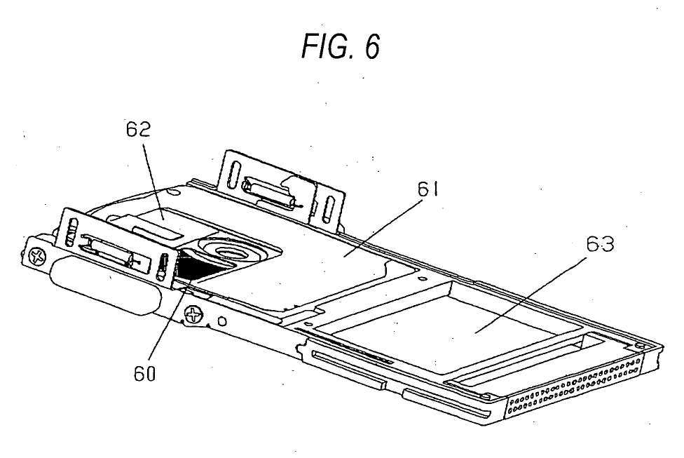

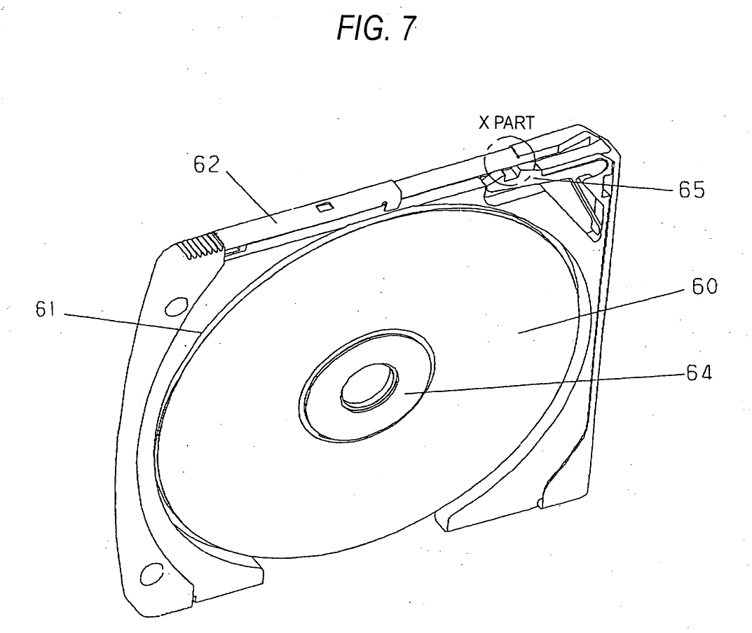

FIG. 6 shows an internal structure of the CF card standard mechanism section in which the top cover 52 is removed from a perspective view of FIG. 5 showing an appearance of the CF card standard mechanism section. In FIG. 6, the reference numeral 60 indicates an optical disk, the reference numeral 61 indicates an optical disc cartridge which accommodates the optical disk 60, the reference numeral 62 indicates a cartridge shutter which is mounted on the optical disc cartridge 61, and the reference numeral 63 indicates a CF card standard mechanism section circuit board. FIG. 7 is a perspective view showing an internal structure of the optical disk cartridge 61. The reference numeral 64 indicates a metallic ring which is fixed to the optical disk 60, and the reference numeral 65 indicates a shutter mooring member which moors the cartridge shutter 62 in a portion X in FIG. 7.

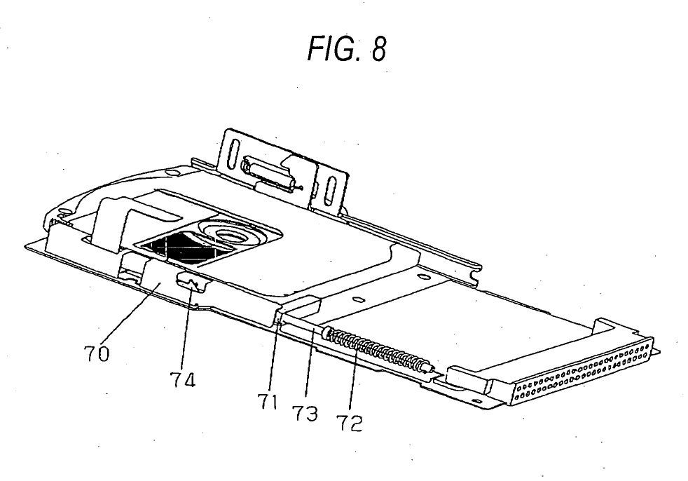

FIG. 8 shows an internal structure of the CF card standard mechanism section 101 in which the CF card standard mechanism section frame 51 is removed from the internal structural view of the CF card standard mechanism section in FIG. 6.

The reference numeral 70 indicates a cartridge tray which holds the optical disk cartridge 61 when the optical disk cartridge 61 is inserted into the CF card standard mechanism section 101, the reference numeral 71 indicates a cartridge ejection member for ejecting the optical disk cartridge 61 from the CF card standard mechanism section 101, the reference numeral 72 indicates a cartridge ejection spring which serves as a power source which pushes out the cartridge ejection member 71, the reference numeral 73 indicates a cartridge ejection shaft which transmits the power from the cartridge ejection spring 72 to the cartridge ejection member 71, and the reference numeral 74 indicate a cartridge ejection member fixing spring.

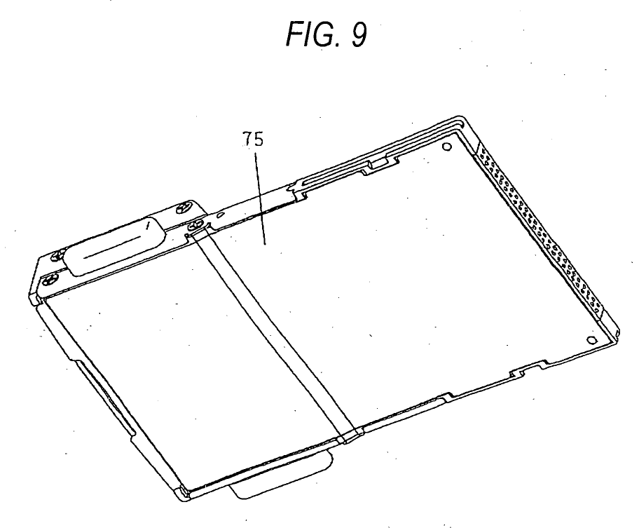

FIG. 9 shows a bottom surface of the CF card standard mechanism section 101. The reference numeral 75 indicates a bottom cover which covers the bottom surface of the CF card standard mechanism section frame.

Next, an operation method, an operation and conditions based on the CF card standard of the information reproducing device (optical disk drive) of the present invention will be described.

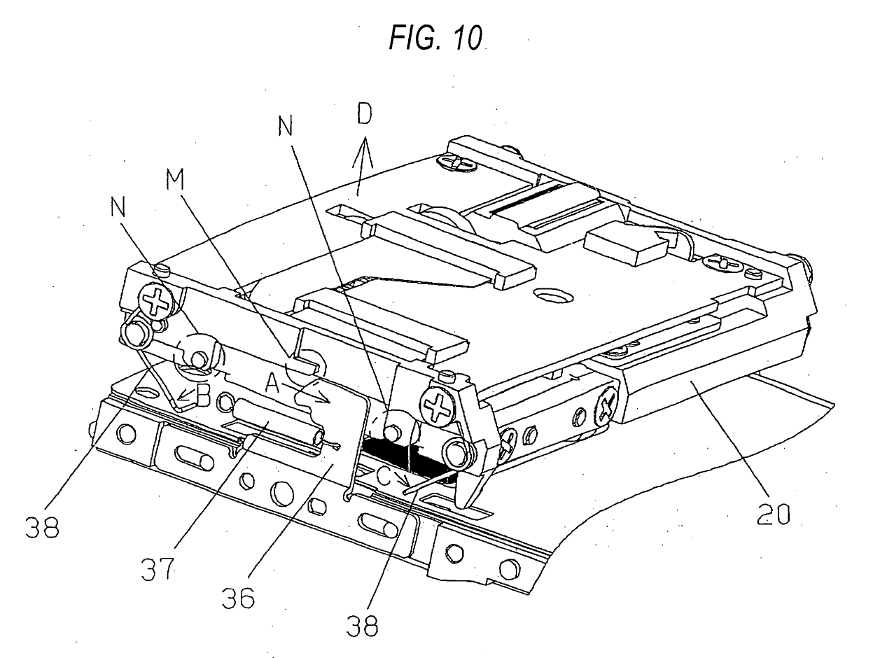

First, when the optical disk cartridge 61 having the optical disk 60 accommodated therein is inserted into the CF card standard mechanism section 101, as shown in FIG. 10, the lateral mooring biasing springs 37 applies a biasing force to the lateral mooring members 36 in a direction opposite to the direction that the lateral mooring member 36 is moved, to thereby move each slide button 39 toward the CF card standard connector 50.

In this case, the slide button 39 is moved toward (direction A) the CF card standard connector 50. This operation of the slide button 39 prevents the CF card standard connector 50 from falling out of a portable apparatus such as a PDA in a state in which the information reproducing device of the present invention is connected to the portable apparatus.

When the slide button 39 is operated in the direction A, convex portions (portions M) provided on both sides of the recording and reproducing mechanism main body 20 comes out of the lateral mooring members 36. Then, the recording and reproducing mechanism main body lifting springs 38 which are respectively mounted by two, i.e., a total sum of four, on the right and left sides of the recording and reproducing mechanism main body 20 are opened in directions B and C, to thereby lift the recording and reproducing mechanism main body 20 in a direction D. In this case, in the present invention, the recording and reproducing mechanism main body lifting spring 38 may be a torsion spring or a compression spring.

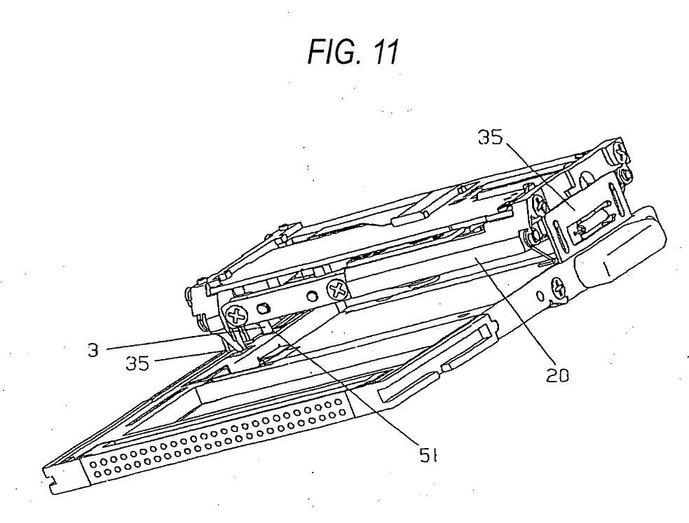

In this case, in the recording and reproducing mechanism main body 20, bosses (portions M) provided on both sides of the recording and reproducing mechanism main body 20 are regulated by grooves provided at the lateral guide members 35. Thus, as shown in FIG. 4, a raised position of the recording and reproducing mechanism main body 20 is also restricted. In this case, lower portions of the bossed portions M which are provided on both sides of the recording and reproducing mechanism main body 20 and which move in the grooves provided in the lateral guide members 35 becomes points of forces of the recording and reproducing mechanism main body lifting springs 38. Thus, the recording and reproducing mechanism main body 20 can be efficiently and smoothly lifted in the vertical direction. Further, as shown in FIG. 11, since the recording and reproducing mechanism main body 20 is raised in the vertical direction, a bottom surface of the recording and reproducing mechanism main body 20 is provided with the vertical guide members 3, the CF card standard mechanism section frame 51 is formed with holes into which the vertical guide members 3 are respectively fitted. Thus, the recording and reproducing mechanism main body 20 is raised in the vertical direction. Here, it is necessary that the optical disk drive of the present invention has a card shape and the optical disk drive itself has enhanced rigidity. The lateral guide members 35 are made of a metallic material. Thus, the optical disk drive can have enhanced rigidity and a grounding function set to the CF card standard.

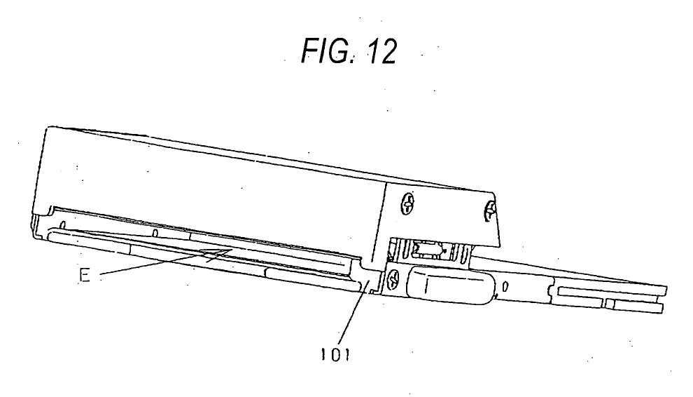

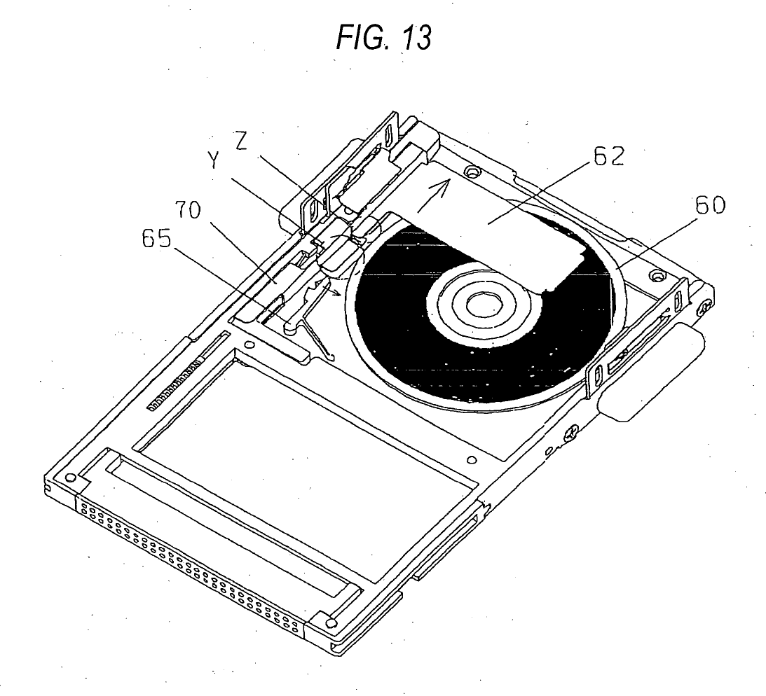

As the recording and reproducing mechanism main body 20 is raised in the vertical direction, as shown in FIG. 12, an optical disk cartridge insertion slot appears at a front portion of the CF card standard mechanism section 101. If an operator of the optical disk drive of the present invention inserts the optical disk cartridge 61 into the insertion slot, the inserted optical disk cartridge 61, as shown in FIG. 13, is inserted into the optical disk drive along the cartridge tray 70 (direction E).

Moreover, a bent portion Y provided in the cartridge tray 70 actuates the shutter mooring member 65 provided inside the optical disk cartridge 61, thereby releasing the restraint on a portion Z of the cartridge shutter 62 which the shutter mooring member 65 engages. Then, the cartridge shutter 62 is actuated which results in a state in which the optical disk 60 can be viewed from the outside of the optical disk cartridge 61.

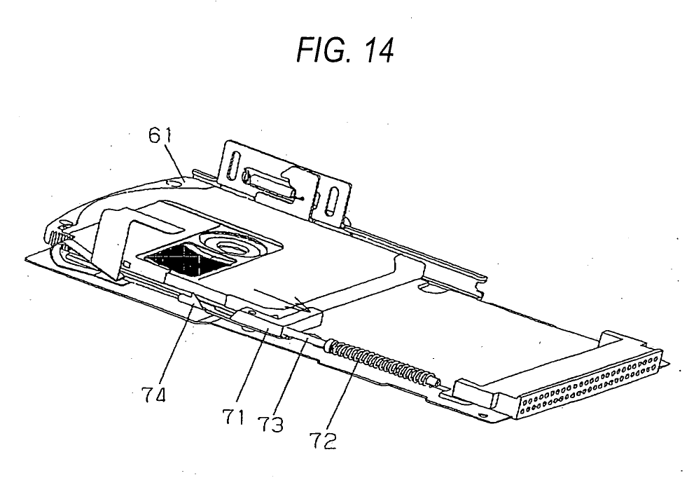

While the optical disk cartridge 61 is inserted into the cartridge tray 70, as shown in FIG. 14, a rear portion of the optical disk cartridge 61 pushes down the cartridge ejection member 71 in a direction that the optical disk cartridge 61 is inserted.

The cartridge ejection shaft 73 is attached to the cartridge ejection member 71, and the cartridge ejection spring 72 is attached to the cartridge ejection shaft 73. Thus, simultaneously when the cartridge ejection member 71 is pushed down, the cartridge ejection spring 72 is compressed.

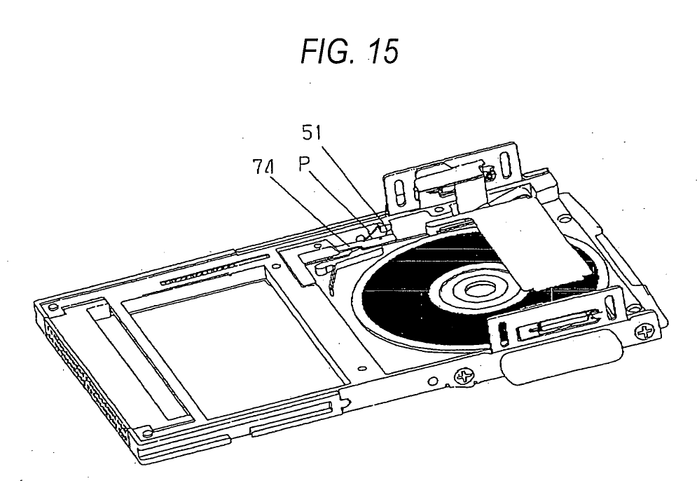

As shown in FIG. 15, the cartridge ejection member 71 is pushed down and fixed until an arrow-shaped portion at a tip of the cartridge ejection member fixing spring 74 which is fixed to the cartridge ejection member 71 engages the convex portion provided on the side of the CF card standard mechanism section frame 51, as indicated by a portion P.

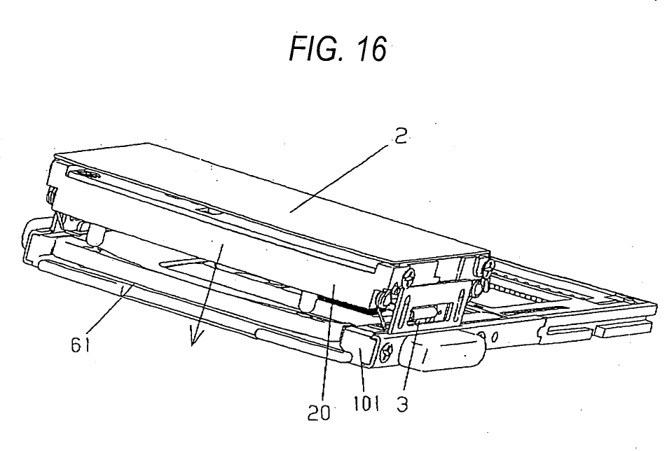

When the operation of the optical disk cartridge 61 inserted into the CF card standard mechanism section 101 is completed, the operator of the optical disk drive of the present invention applies a pressing force to the metallic cover 2 toward the bottom surface thereof, thereby lowering the metallic cover 2 along the vertical guide member 3, as shown in FIG. 16. When the recording and reproducing mechanism main body 20 is lowered, the two boss-shaped portions provided on the bottom surface of the recording and reproducing mechanism main body 20 coincide with positioning holes of the optical disk cartridge, the optical disk cartridge 61 is positioned at a fixed position, the metallic ring 64 fixed to the optical disk 60 is attracted to a magnet attached to a tip of the spindle motor 22, and the optical disk 60 is fixed to the tip of the spindle motor 22. At this time, since the fixed metallic ring 64 is fixed to a surface of the optical disk 60 opposite to the surface where the spindle motor 22 exists with adhesive or the like, and the magnet attached to the spindle motor 22 does not directly attract the fixed metallic ring 64, even if an adhesive for attaching the fixed metallic ring 64 deteriorates due to a change with the lapse of time, the magnet attached to the spindle motor 22 does not extract the metallic ring 64 attached to the optical disk 60.

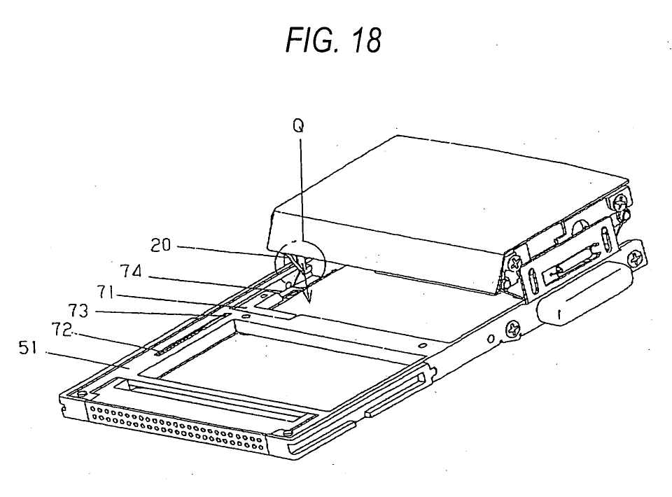

When the recording and reproducing mechanism main body 20 is lowered, as shown in FIG. 18, a convex portion Q provided on the bottom surface of the recording and reproducing mechanism main body 20 applies a pressing force to the cartridge ejection member fixing spring 74, the cartridge ejection member fixing spring 74 is bent by the pressing force, an arrow-shaped portion of the convex portion Q comes out of the convex portion provided on the side of the CF card standard mechanism section frame 51, and the cartridge ejection member 71 receives the pressing force through the cartridge ejection shaft 73 by energy accumulated by the compressed cartridge ejection spring 72. As a result, the cartridge ejection member 71 which becomes free from its moored state applies a pressing force for ejecting the optical disk cartridge 61 thereto. Also, when the operator of the optical disk drive of the present invention operates the slide button 39 in order to remove the optical disk cartridge 61, and the recording and reproducing mechanism main body 20 is raised, the optical disk cartridge 61 is ejected from the cartridge tray 70.

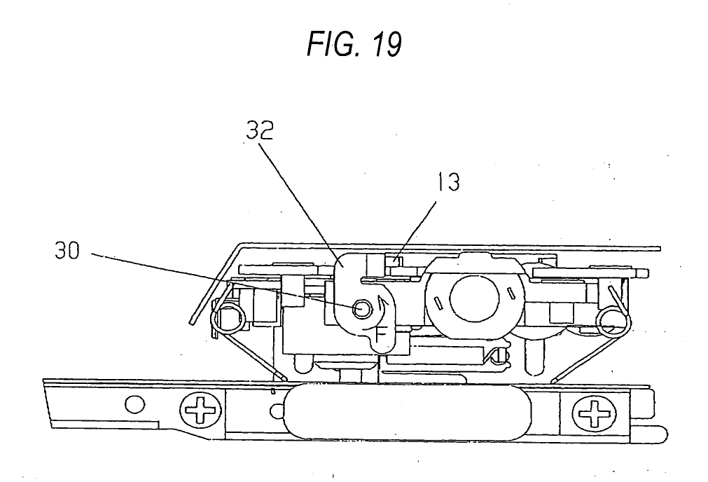

Simultaneously when the recording and reproducing mechanism main body 20 is lowered, as shown in FIG. 19, a lower end of the recording and reproducing mechanism section vertical movement sensing lever 32 having the motor fixing member 30 provided with a sliding shaft begins to contact the bottom cover 52, and the recording and reproducing mechanism section vertical movement sensing lever 32 is actuated to rotate in a direction F. As a result, when the electronic switch 13 as shown in FIG. 3 is actuated, and an electric current flows through the electronic switch 13, the recording and reproducing mechanism section vertical movement sensing lever 32 senses that the recording and reproducing mechanism main body 20 has been completely lowered.

When the recording and reproducing mechanism section vertical movement sensing lever 32 senses that the recording and reproducing mechanism main body 20 has been completely lowered, the optical pickup module 21 rotates the lead screw shaft 23 via the motor gear 29, the intermediate gear 27 and the lead screw shaft gear 25, as the feed motor 28 rotates. Then, the lead screw shaft pressing spring 26 pushed against the rotating lead screw shaft 23 transmits a rotational force to the optical pickup module 21, and the optical pickup module 21 is actuated between the inner periphery and the outer periphery of the optical disk 60 along the guide shaft 33. At this time, the photointerrupter 31 counts the circular shielding plate having a slit provided at a central position of the intermediate gear 27, thereby counting the number of revolutions of the motor. That is, the traveling distance of the optical pickup module 21 is measured to control the operation of the optical pickup module 21.

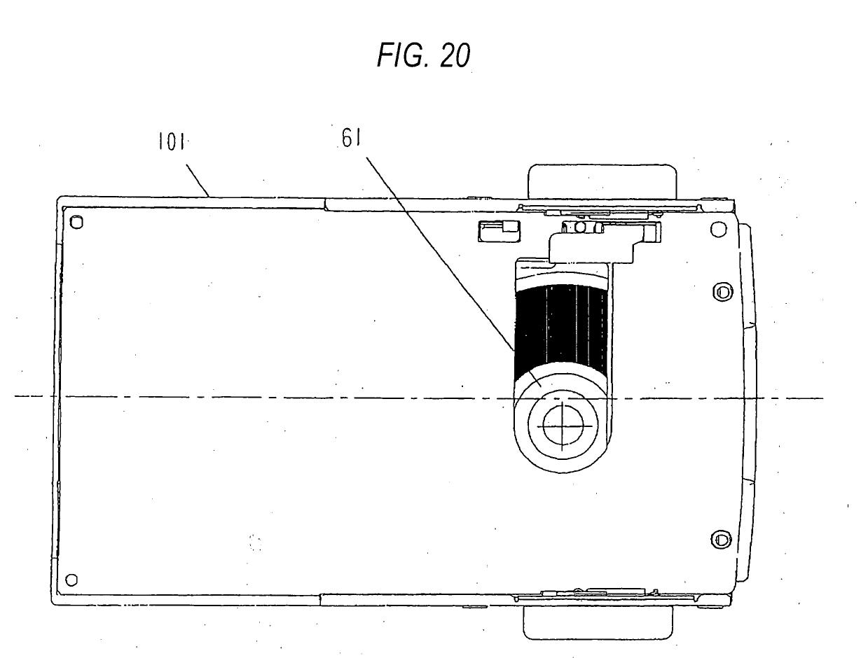

FIG. 20 shows a top plan view of the CF card standard mechanism section 101. As can be understood from FIG. 20, if the width of the optical disk cartridge 61 is approximate to that of the CF card standard mechanism section 101, and if the central position of the CF card standard mechanism section 101 coincides with the central position of the optical disk cartridge 61, it is difficult to construct the cartridge ejection member 71, the cartridge ejection spring 72, the cartridge ejection shaft 73, and the cartridge ejection member fixing spring 74 in space left at both ends of the CF card standard mechanism section 101. Thus, in the optical disk drive of the present invention, as shown in FIG. 20, the central position of the optical disk cartridge 61 are shifted from the central position of the CF card standard mechanism section 101, so that a space for installing the cartridge ejection member 71, the cartridge ejection spring 72, the cartridge ejection shaft 73, and the cartridge ejection member fixing spring 74 are provided at one side.

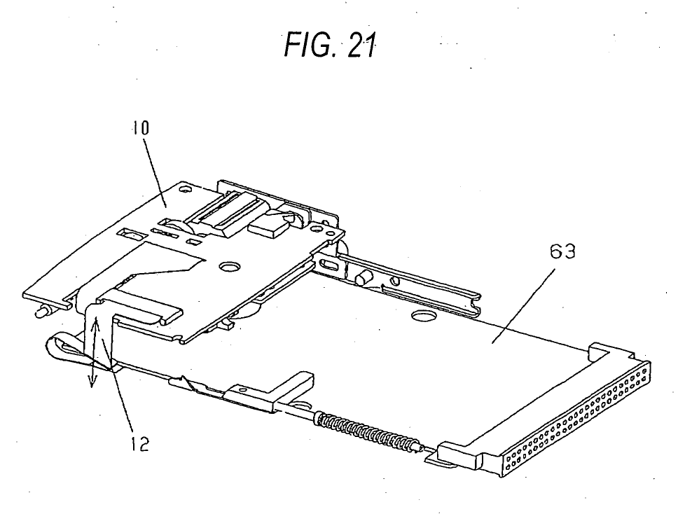

Moreover, the vertical guide member 3 which guides the vertical movement of the recording and reproducing mechanism section 100 is provided in the space provided at the one side, or as shown in FIG. 21, the inter-board FPC 12 which connects the recording and reproducing mechanism section internal circuit board with the CF card standard mechanism section circuit board 63 is attached to be bent so that the inter-board FPC 12 is actuated to follow the vertical movement of the recording and reproducing mechanism section 100.

Next, a structure corresponding to the thinnest card standard available on the market, i.e., CF Card Type 1 Standard will be described. In the CF card standard, the smallest standard value of the sectional height of the CF card standard mechanism section is 3.3 mm. In the present invention, the optical disk drive of the present invention is miniaturized, so that the optical disk cartridge 61 is disposed to fall within a standard value of 3.3 mm that is CF Card Type 1 Standard, as shown in FIGS. 5, 6, 8 and 10, so as not to deteriorate portability even when the optical disk drive is connected to a portable apparatus such as a PDA. In the present invention, the height dimension of the optical disk cartridge 61 is set to a total sum of 2 mm in which the dimension is allotted such that the bottom cover 75 is a sheet of 0.2 mm made of metal such as Stainless Steel, the cartridge tray 70 for holding the optical disk cartridge 61 is a sheet of 0.15 mm made of metal such as Stainless Steel, the CF card standard mechanism section circuit board 63 is set to 0.5 mm, and the remainder is set to 0.35 mm as inter-component clearance. Naturally, if the height dimension of the optical disk of the optical disk cartridge 61 can be made small, the height dimensions of other components can be increased, which makes it possible to increase the rigidity or the like of the recording and reproducing apparatus (optical disk drive) itself of the present invention can be enhanced.

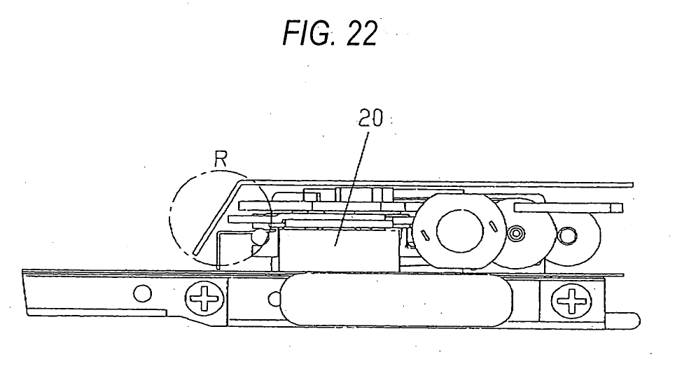

As a construction of the components, the top cover 52, the optical disk cartridge 61, the cartridge tray 70, the CF card standard mechanism section circuit board 63, and the bottom cover 63 are constructed in this order from the top surface of the CF card standard mechanism section 101 so that the internal space of the CF card standard mechanism section 101 can be efficiently utilized. Moreover, in order to miniaturize the optical disk drive of the present invention, as shown in FIG. 22, an inclined portion R set to a shape standard of the CF card is disposed on the bottom surface of the spindle motor 22. That is, the central position of the optical disk 60 is provided at the inclined portion set to the shape standard of the CF card, or provided as close to the inclined portion as possible, so that the position of the optical disk cartridge 61 can be shifted in a height range of 3.3 mm that is the CF Card Type 1 Standard.

Generally, as the spindle motor, a peripheral opposite type motor is mounted on an optical disk drive which is commonly available on the market. However, in order to further decrease the height of the spindle motor, a motor which uses ceramic coils which are printed and laminated at high density which allows the width of lines to be decreased and the pitch between the lines to be narrowed is utilized, so that the height dimension of the spindle motor can be decreased, and the position of the optical disk cartridge can be shifted in a height range of 3.3 mm which is the CF Card Type 1 Standard. Thus, in the optical disk drive of the present invention, it is possible to improve the portability of the optical disk drive of the present invention because the lengthwise dimension can be further shortened.

According to the present invention, while the connector unit is connected to other apparatus, the medium inserting unit can be opened or closed by raising or lowering the lifting unit. Thus, in a state in which the information reproducing device is connected to the other apparatus, the medium can be replaced. Also, since the operability is improved, the present invention can be adapted to an information reproducing device capable of reproducing at least information in which the device is can be connected to a portable terminal apparatus such as a portable information apparatus, a cellphone, a portable game machine and the like.

### Second Embodiment

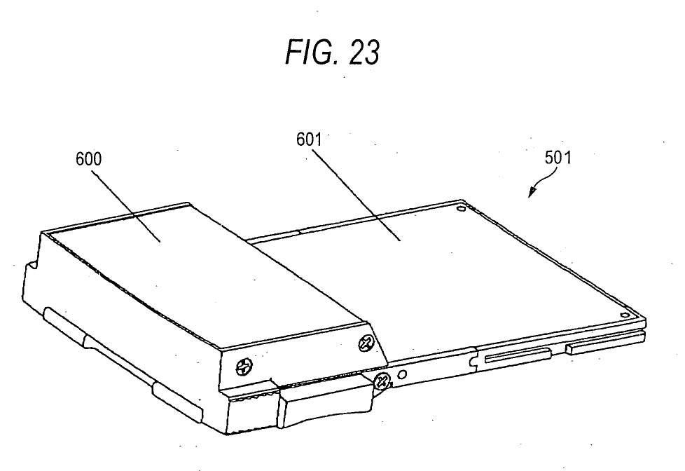

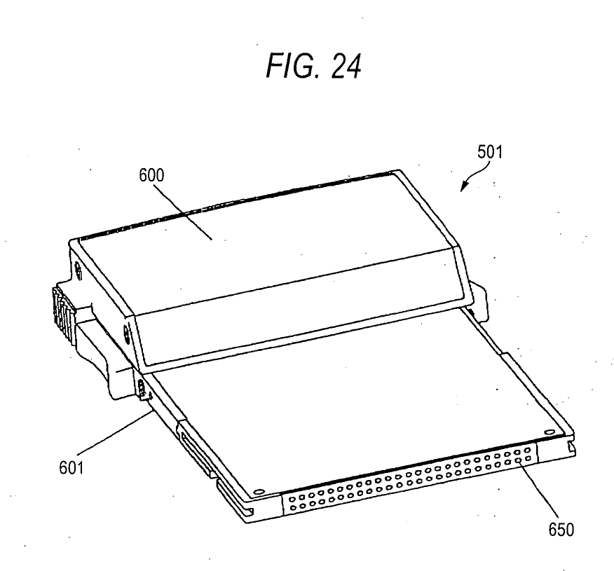

An information reproducing device according to an embodiment of the present invention will be described with reference to FIGS. 23 and 24. FIG. 23 is a side perspective view of the information reproducing device according to the embodiment of the present invention. FIG. 24 is a back perspective view of the information reproducing device according to the embodiment of the present invention.

As shown in FIG. 23, the information reproducing device 501 has a card type mechanism section (main body) 601, and a recording and reproducing mechanism section (lifting unit) 600 having its one axis fixed to the card type mechanism section 601 and which is provided so as to be freely raised or lowered. The recording and reproducing mechanism section 600 has a recording and reproducing device of an optical disk, which either records information on the optical disk or reproduces information from the optical disk. The card type mechanism section 601 has a connector corresponding to a certain card standard.

The card type mechanism section 601 has a space for accommodating an optical disk cartridge having the optical disk accommodated therein, an electrical board having electronic components mounted thereon to process data read by an optical pickup, and a connector 650 which outputs data processed in the electrical board and which connects the information reproducing device 501 with a personal computer or a portable terminal apparatus, as shown in FIG. 24.

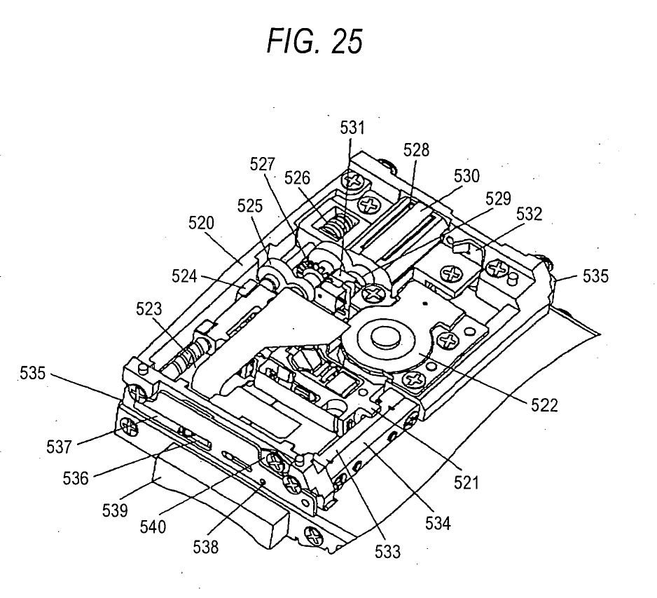

Next, a structure of a recording and reproducing mechanism main body 520 in the recording and reproducing mechanism section 600 will be described with reference to FIG. 25. FIG. 25 is a perspective view showing the structure of the recording and reproducing mechanism main body 520. The recording and reproducing mechanism main body 520 serving as a base of the recording and reproducing mechanism section 600 has an optical pickup module 521 which records information to and reproduces information from the optical disk, a spindle motor 522 which serves as a power source for rotating the optical disk, a lead screw shaft 523 which is threaded to move the optical pickup module 521 to inner and outer circumferential positions of the optical disk, a rack leaf spring 524 which transmits power from the lead screw shaft 523 to the optical pickup module 521 and which holds a flexible printed circuit (hereinafter, referred to as FPC) board which is incorporated into the optical pickup module 521, a lead screw shaft gear 525 fixed to the lead screw shaft 523, a lead screw shaft pressing spring 526 which presses the lead screw shaft 523 in an arbitrary direction, an intermediate gear 527 having gears on both sides thereof and a circular shielding plate which is provided with a slit at its central portion, a feed motor 528 serving as a power source which rotates the lead screw shaft 523, a motor gear 529 mounted to a rotating shaft of the feed motor 528, a motor fixing member 530 for holding the feed motor 528, and a photointerupter 531 for measuring the number of revolutions of the intermediate gear so as to measure the number of revolutions of the feed motor 528. Further, the recording and reproducing mechanism main body 520 has a recording and reproducing mechanism section vertical movement sensing lever 532 for sensing the vertical movement of the recording and reproducing mechanism section 600 when the optical disk cartridge having the optical disk incorporated therein is attached to or detached from the information reproducing device 501, a guide shaft 533 for regulating or guiding the movement of the optical pickup module 521 to inner and outer circumferential positions of the optical disk, a guide shaft fixing member 534 for fixing the guide shaft 533 to the recording and reproducing mechanism main body 520, metallic lateral guide members 535 mounted on both sides of the card type mechanism section 601, claw-shaped lateral mooring members 536 which are mounted on both sides of the card type mechanism section 601 and which moor the recording and reproducing mechanism main body 520, lateral mooring biasing springs 537 for applying biasing forces in arbitrary directions to the lateral mooring members 536 respectively, recording and reproducing mechanism main body lifting springs 538 including a torsional spring which lift the recording and reproducing mechanism main body 520, when the optical disk cartridge having the optical disk incorporated therein is attached to or detached from the information reproducing device 501, slide buttons 539 fixed to the lateral mooring members 536, and lift regulating members 540 for regulating a raised position of the recording and reproducing mechanism main body 520.

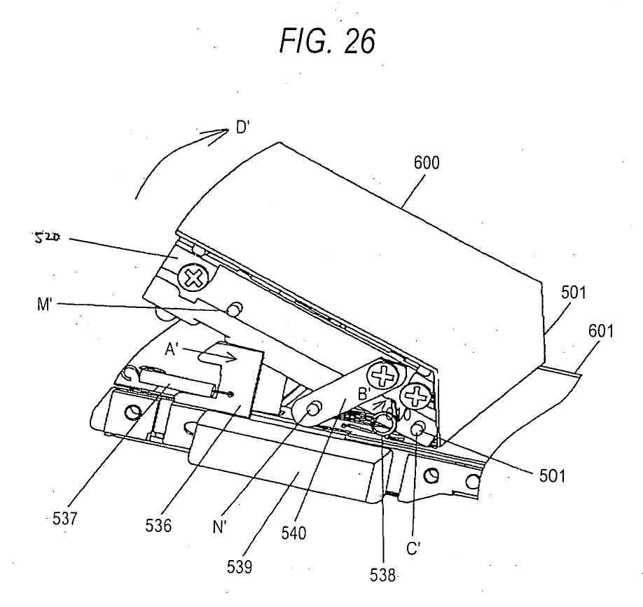

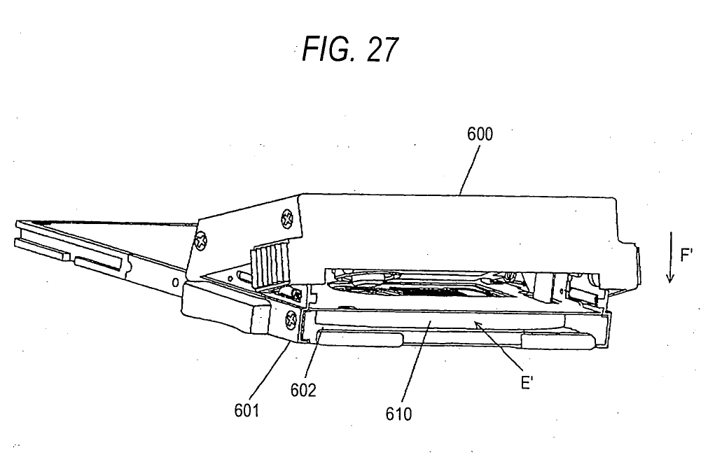

Next, a lifting mechanism of the recording and reproducing mechanism 600 when the optical disk cartridge having the optical disk accommodated therein is inserted into or ejected from the information reproducing device 501 while the information reproducing device 501 is connected to other terminal apparatuses will be described with reference to FIGS. 26 and 27. FIG. 26 shows a state in which the recording and reproducing mechanism section 600 is raised or lowered. FIG. 27 is a perspective view showing a state in which the recording and reproducing mechanism section 600 is raised.

The information reproducing device 501 is connected to the terminal apparatus by the connector 650. Here, when the optical disk cartridge 510 having the optical disk accommodated therein is inserted into the card type mechanism section 601, as shown in FIG. 26, the slide buttons 539 fixed to the lateral mooring members 536 are moved in a direction (direction A′) of the connector 650. In this case, the lateral mooring biasing springs 537 applies a biasing force to the lateral mooring members 536 in a direction opposite to the direction that the lateral mooring members are moved. If the slide buttons 539 is operated in the direction A, convex portions (portions M′) provided on both sides of the recording and reproducing mechanism main body 520 comes out of the lateral mooring members 536. If doing so, the recording and reproducing mechanism main body lifting springs 538 which are respectively mounted on both sides of the recording and reproducing mechanism main body 520 are opened in a direction B′, and the recording and reproducing mechanism main body 520 is lifted in a direction D′ about an axis I of a boss-shaped portion (portion C′) as a fulcrum. At this time, boss-shaped portions provided on sides (portions N′) of the lift regulating members 540 which are mounted on both sides of the recording and reproducing mechanism main body 520 are regulated by grooves provided in the lateral guide members 535. Thus, as shown in FIG. 26, a raised position of the recording and reproducing mechanism main body 520 is regulated. When the recording and reproducing mechanism main body 520 is raised, as shown in FIG. 27, a front portion of the card type mechanism section 601, that is, the inserting unit 602 of the optical disk cartridge 610 appears in a position opposite to the connector 650. An operator of the information reproducing device 1 inserts the optical disk cartridge 610 in a direction E′ from the inserting unit 602. The inserted optical disk cartridge 610 is inserted into the card type mechanism section 601.

When the optical disk cartridge 610 is completely inserted into the card type mechanism section 601, the operator of the information reproducing device 501 lowers the recording and reproducing mechanism section 600 by pressing the recording and reproducing mechanism section 600 in a direction F′. The convex portions (portions M′) are moored in the lateral mooring members 536, and the recording and reproducing mechanism section 600 is moored in the card type mechanism section 601. Then, the information reproducing device 501 becomes an operable state.

Further, when the optical disk cartridge 610 having the optical disk accommodated therein is ejected from the card type mechanism section 601, the same operation also is performed. As a result, the optical disk cartridge 610 having the optical disk accommodated therein can be ejected from the card type mechanism section 601.

As described above, the inserting unit 602 of the optical disk cartridge 610 is provided in a direction opposite to the connector 650 and the position of the fulcrum where the recording and reproducing mechanism section 600 is opened or closed is set to an axis. Thus, the optical disk cartridge 610 can be inserted and ejected in the direction opposite to the connector 650 of the card type mechanism section 601. Accordingly, while the information reproducing device 501 is connected to the terminal apparatus, the optical disk cartridge 610 can be inserted or ejected. As a result, operability of inserting or ejecting the optical disk cartridge 610 can be improved.

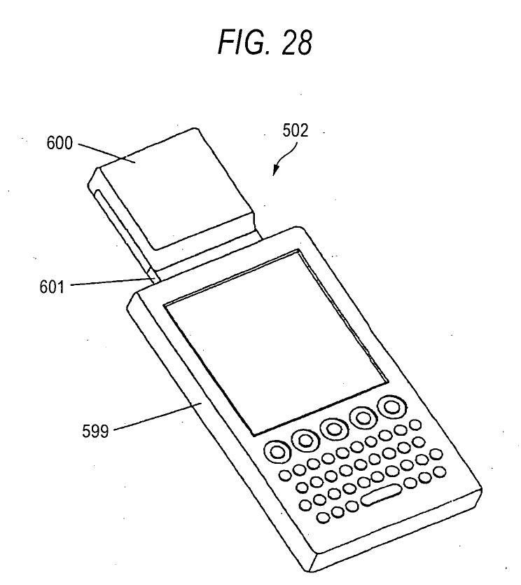

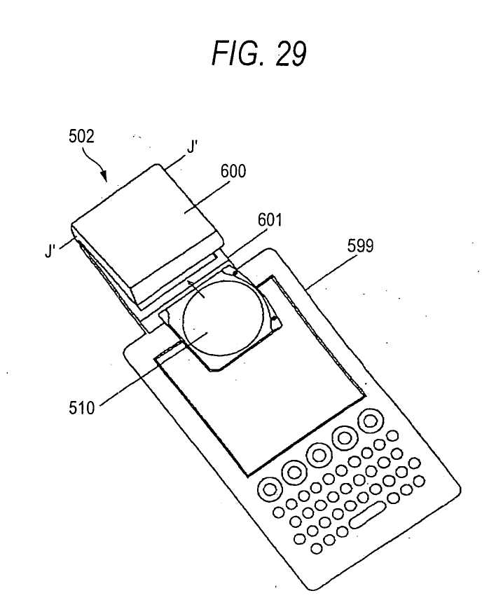

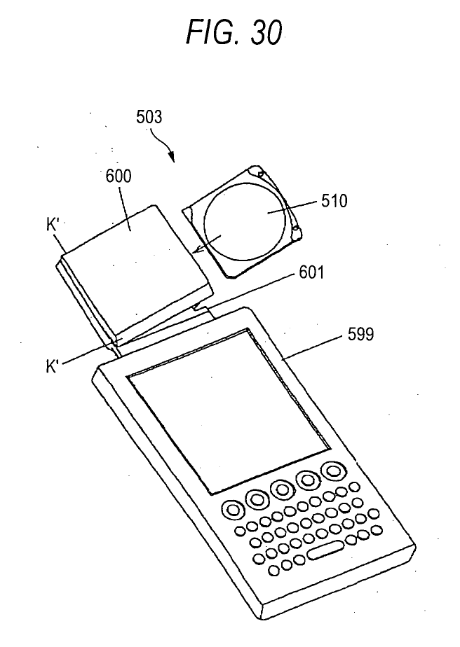

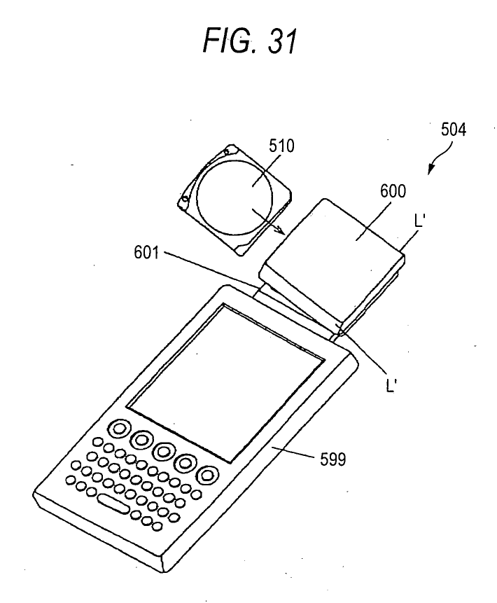

Here, modifications of the embodiment of the present invention will be described with reference to FIGS. 28 to 31. FIG. 28 shows a first modification of the embodiment of the present invention, and FIG. 29 shows a state in which the optical disk cartridge is inserted, in the first modification of the embodiment of the present invention. FIGS. 30 and 31 show second and third modifications of the embodiment of the present invention, respectively.

According to the first modification of the embodiment of the present invention, as shown in FIG. 28, an information reproducing device 502 is connected to a portable terminal apparatus 599 such as a personal digital assistant (PDA) or the like via the connector 650. In a state in which an operator of the information reproducing device 502 holds the portable terminal apparatus 599 with his/her hands, when the optical disk cartridge 610 is inserted into or ejected from the card type mechanism section 601, as shown in FIG. 29, the position of the fulcrum where the recording and reproducing mechanism section 600 is opened or closed is set to an axis J′. Accordingly, the optical disk cartridge 610 can be inserted or ejected in a direction of the connector 550 of the card type mechanism section 601. As such, while the information reproducing device 502 is connected to the portable terminal apparatus 599, the optical disk cartridge 610 can be inserted or ejected. As a result, the operability of inserting or ejecting the optical disk cartridge 610 can be improved.

Further, there is a case in which it is difficult for the optical disk cartridge 610 to be inserted from the same direction as the direction connected to the portable terminal apparatus 599 due to a positional limitation of a switch or the like provided in the portable terminal apparatus 599. In this case, the information reproducing device 501 according to the embodiment of the present invention may be constructed like an information reproducing device 503 of the second modification. According to the second modification, the position of the fulcrum where the recording and reproducing mechanism section 600 is opened or closed is set to an axis K′, as shown in FIG. 30. Thus, the optical disk cartridge 510 is inserted or ejected from the right with respect to the direction that the connector 650 of the card type mechanism section 601 is connected.

Further, the information reproducing device 501 according to the embodiment of the present invention may be constructed like an information reproducing device 504 of the third modification. According to the third modification, as shown in FIG. 31, the position of the fulcrum where the recording and reproducing mechanism section 600 is opened or closed is set to an axis L′. Thus, the optical disk cartridge 610 is inserted or ejected from the left with respect to the direction that the connector 550 of the card type mechanism section 601 is connected.

As such, while the information reproducing device 503 or 504 is connected to the portable terminal apparatus 599, the optical disk cartridge 610 can be inserted or ejected. Thus, the operability of inserting or ejecting the optical disk cartridge 610 can be improved.

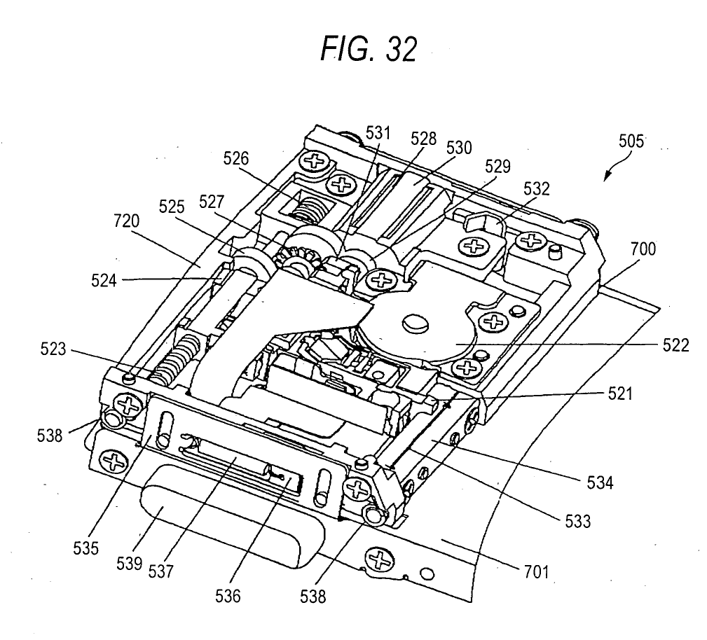

Next, another embodiment of the present invention will be described with reference to FIG. 32. FIG. 32 is a perspective view showing a structure of a recording and reproducing mechanism main body 720 of an information reproducing device 505 according to another embodiment of the present invention.

The information reproducing device 505 according to another embodiment of the present invention has a recording and reproducing mechanism section 700 and a card type mechanism section 701. The structure of the card type mechanism section 701 and the structure of the recording and reproducing mechanism main body 720 are the same as those in the information reproducing device 501 according to the above-mentioned embodiment of the present invention, respectively. Thus, the same elements are represented by the same reference numerals, and the descriptions thereof will be omitted.

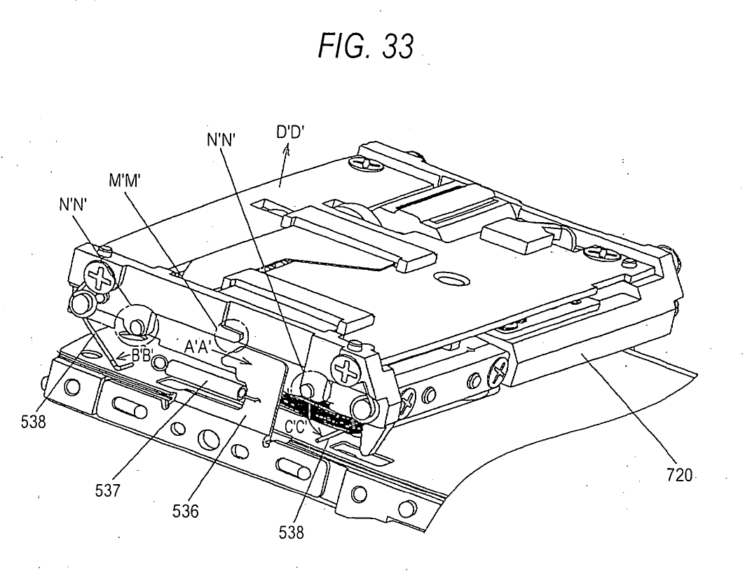

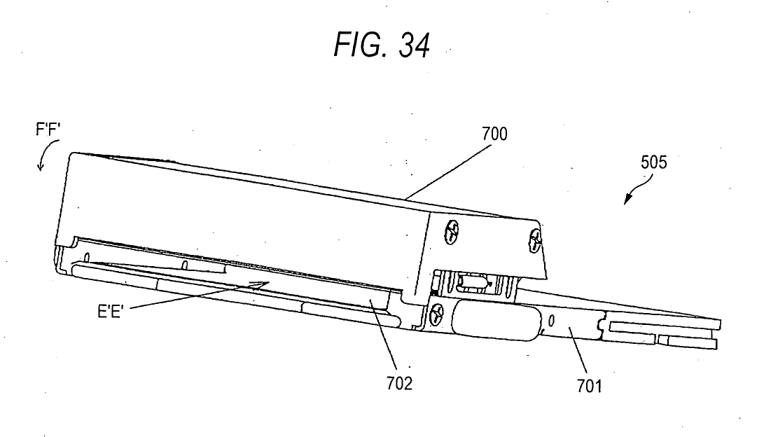

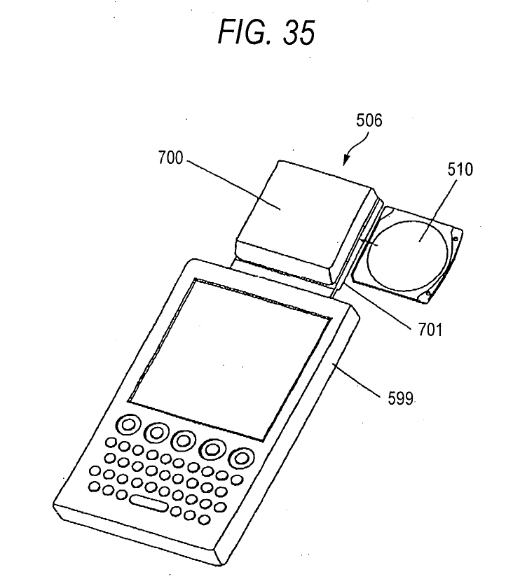

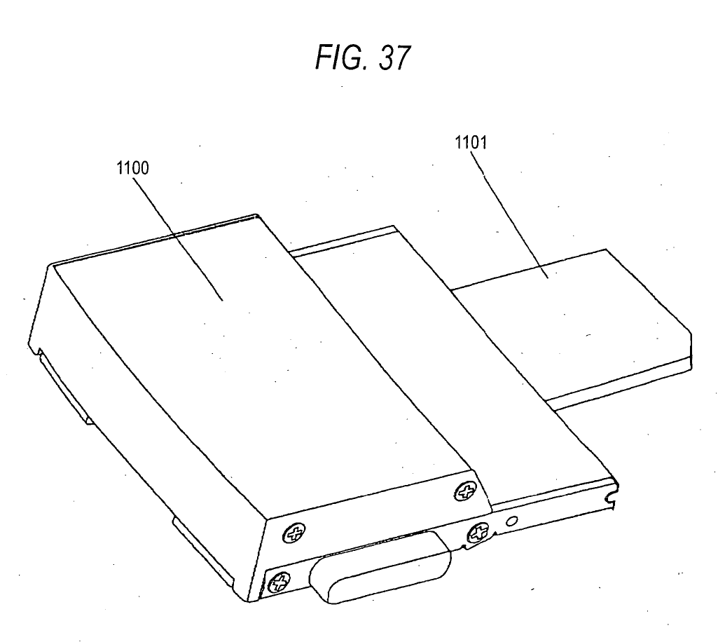

Next, a lifting mechanism of the recording and reproducing mechanism section 700 when the optical disk cartridge 610 having the optical disk accommodated therein is inserted into or ejected from the information reproducing device 505 according to another embodiment of the present invention while the information reproducing device 505 is connected to a terminal apparatus will be described with reference to FIGS. 35 and 37. FIG. 33 shows a state in which the recording and reproducing mechanism section 700 is raised or lowered. FIG. 34 is a perspective view showing a state in which the recording and reproducing mechanism section 700 is raised.

The information reproducing device 505 is connected to the terminal apparatus by means of the connector 650. Here, when the optical disk cartridge 610 having the optical disk accommodated therein is inserted into the card type mechanism section 701, as shown in FIG. 33, the slide buttons 539 (not shown) fixed to the lateral mooring members 536 are moved in a direction (direction A′A′) the connector 650. At this time, the lateral mooring biasing springs 537 applies a biasing force to the lateral mooring members 536 from the direction opposite to the direction that the lateral mooring members are moved. When the slide buttons 539 are operated in the direction A′A′, convex portions (portions M′M′) provided on both sides of the recording and reproducing mechanism main body 720 comes out of the lateral mooring members 536. If doing so, the recording and reproducing mechanism main body lifting springs 538 which are respectively mounted by two on both sides of the recording and reproducing mechanism main body 720 are opened in directions B′B′ and C′C′ respectively, to thereby lift the recording and reproducing mechanism main body 720 perpendicularly in a direction D′D′. At this time, boss-shaped portions (portions N′N′) provided on both sides of the recording and reproducing mechanism main body 720 are regulated by grooves provided in the lateral guide members 535. Thus, as shown in FIG. 33, a raised position of the recording and reproducing mechanism main body 720 is regulated. Then, when the recording and reproducing mechanism main body 720 is raised, as shown in FIG. 34, a front portion of the card type mechanism section 701, that is, the inserting unit 702 of the optical disk cartridge 610 appears in a position opposite to the connector 650. An operator of the information reproducing device 505 inserts the optical disk cartridge 610 (not shown) in a direction EE into the inserting unit 702. The inserted optical disk cartridge 610 is inserted into the card type mechanism section 701.

When the optical disk cartridge 610 is completely inserted into the card type mechanism section 701, the operator of the information reproducing device 505 lowers the recording and reproducing mechanism section 700 by pressing the recording and reproducing mechanism section 700 in a direction F′F′. The convex portions (portions M′M′) shown in FIG. 33 are moored in the lateral mooring members 536, and the recording and reproducing mechanism section 700 is moored in the card type mechanism section 701. Then, the information reproducing device 505 becomes an operable state.

Further, when the optical disk cartridge 610 having the optical disk accommodated therein is ejected from the card type mechanism section 701, the same operation is performed. As a result, the optical disk cartridge 610 having the optical disk accommodated therein can be ejected from the card type mechanism section 701.

As such, the inserting unit 702 of the optical disk cartridge 610 is provided in a direction opposite to the connector 650 and the recording and reproducing mechanism section 700 can be lowered and raised perpendicularly. Thus, the optical disk cartridge 610 can be inserted and ejected in the direction opposite to the connector 650 of the card type mechanism section 701. Accordingly, while the information reproducing device 505 is connected to the terminal apparatus, the optical disk cartridge 610 can be inserted or ejected. As a result, the operability of inserting or ejecting the optical disk cartridge 610 can be improved.

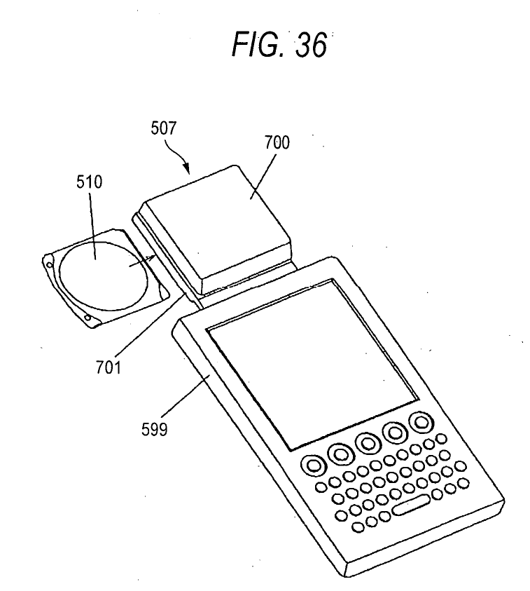

Here, modifications of another embodiment of the present invention will be described with reference to FIGS. 35 to 36. FIG. 35 shows a first modification of another embodiment of the present invention. FIG. 36 shows a second modification of another embodiment of the present invention.

According to the first modification of another embodiment of the present invention, as shown in FIG. 35, an information reproducing device 506 is connected to the portable terminal apparatus 599 via the connector 650. In a state in which an operator of the information reproducing device 506 holds the portable terminal apparatus 599 with his/her hands, when the optical disk cartridge 610 is inserted into or ejected from the card type mechanism section 701, as shown in FIG. 35, the inserting unit 702 of the optical disk cartridge 610 is provided on the right with respect to the direction that the connector 650 is connected. Thus, the optical disk cartridge 610 can be inserted or ejected from the right with respect to the direction that the connector 650 of the card type mechanism section 701 is connected.

Further, according to the second modification of another embodiment of the present invention, as shown in FIG. 36, an information reproducing device 507 has the inserting unit 702 of the optical disk cartridge 610 which is provided on the left with respect to the direction that the connector 650 is connected. Thus, the optical disk cartridge 610 can be inserted or ejected from the left with respect to the direction that the connector 650 of the card type mechanism section 701 is connected.

As described, while the information reproducing device 506 or 507 is connected to the portable terminal apparatus 599, the optical disk cartridge 610 can be inserted or ejected. Thus, the operability of inserting or ejecting the optical disk cartridge 610 can be improved.

According to the present invention, while the connector unit is connected to the terminal apparatus, the medium inserting unit can be opened or closed by raising or lowering the lifting unit. Thus, the present invention can be adapted to the information reproducing device capable of reproducing at least information in which the device can be connected to a portable terminal apparatus such as a portable information apparatus, a cellphone, a portable game machine and the like, and a personal computer.

### Third Embodiment

Hereinafter, an embodiment of the present invention will be described with reference to the accompanying drawings.

As shown in FIG. 37, an information reproducing device according to the present embodiment generally comprises a recording and reproducing mechanism section 1100 having a recording and reproducing device member (which either records information on an optical disk or reproduces information from the optical disk) of the optical disk, and a connector section 1101 corresponding to a shape of a semiconductor memory.

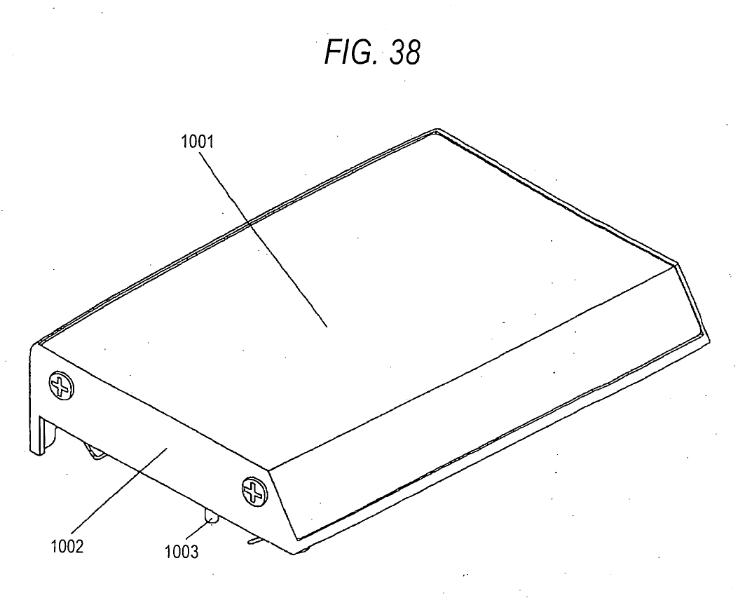

First, the recording and reproducing mechanism section 1100 will be described with reference to FIG. 38. As shown in FIG. 38, the reference numerals 1001 and 1002 indicate covers which cover the recording and reproducing mechanism section 1100, respectively. The cover 1002 constitutes sidewalls, and the cover 1001 constitutes a top surface. That is, the recording and reproducing mechanism section 1100 is covered with the covers 1001 and 1002. The covers 1001 and 1002 may be made of either the same material or materials different from each other. In the best mode, the cover is made of a resinous material and the cover 1001 is made of a metallic material, so that effects such as an improved heat dissipating property and electronic noise leakage prevention of the recording and reproducing mechanism section 1100 can be obtained. Naturally, materials for the covers 1001 and 1002 can be appropriately selected to solve a heat problem, a noise problem, and a problem of mechanical rigidity.

The reference numeral 1003 indicates a vertical guide member made of a material, such as metal, for lifting the recording and reproducing mechanism section 1100 in a vertical direction.

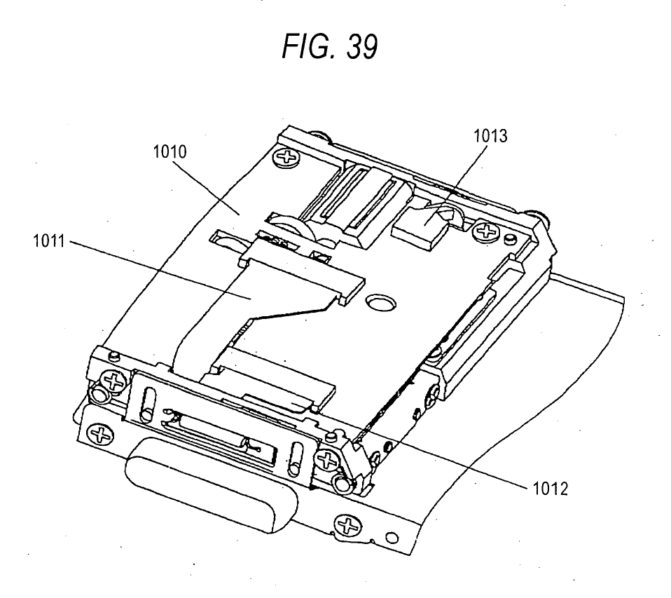

FIG. 39 shows a state in which the covers 1001 and 1002 are removed from the recording and reproducing mechanism section 1100. In FIG. 39, the reference numeral 1010 indicate a recording and reproducing mechanism section internal circuit board which is provided within the recording and reproducing mechanism section 1100, the reference numeral 1011 indicates a flexible printed circuit (hereinafter, referred to as FPC) for an optical pickup signal which transmits and receives a signal read from the optical disk, the reference numeral 1012 indicate an inter-board FPC which transmits a signal to or receives a signal from a circuit board within an SD standard mechanism section, and the reference numeral 1013 indicate an electronic switch which is mounted on the recording and reproducing mechanism section internal circuit board 1010 and which is turned on or off by vertical movement of the recording and reproducing mechanism section 1100.

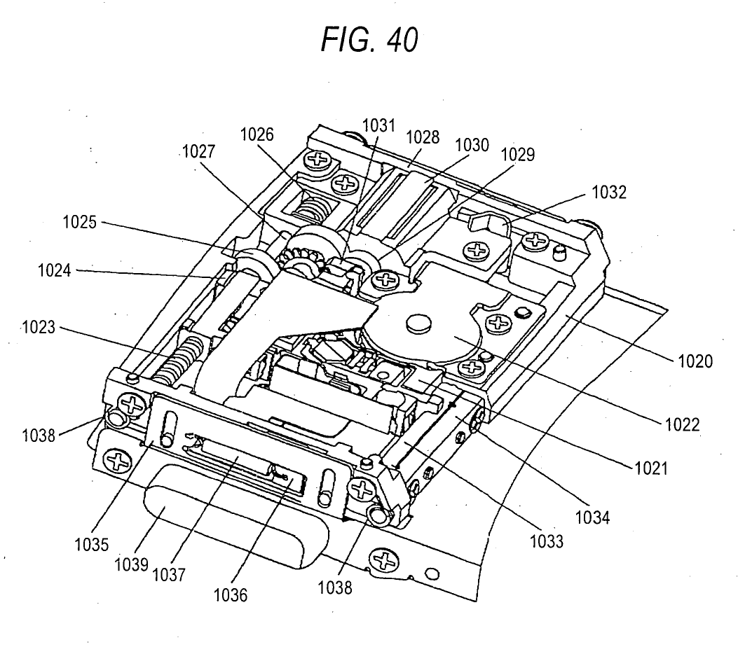

FIG. 40 shows a state in which the recording and reproducing mechanism section internal circuit board 1010 is removed from the recording and reproducing mechanism section 1100 in FIG. 39. The reference numeral 1020 indicates a recording and reproducing mechanism main body serving as a base of the recording and reproducing mechanism section 1100, the reference numeral 1021 indicates an optical pickup module which records information to and reproduces information from the optical disk, the reference numeral 1022 indicates a spindle motor which serves as a power source for rotating the optical disk, the reference numeral 1023 indicates a lead screw shaft which is threaded to move the optical pickup module 1021 to inner and outer circumferential positions of the optical disk, the reference numeral 1024 indicates a rack leaf spring which transmits power from the lead screw shaft 1023 to the optical pickup module 1021 and which holds the FPC incorporated into the optical pickup module 1021, the reference numeral 1025 indicates a lead screw shaft gear fixed to the lead screw shaft 1023, the reference numeral 1026 indicates a lead screw shaft pressing spring which presses the lead screw shaft 1023 in an arbitrary direction, the reference numeral 1027 indicates an intermediate gear having gears on both sides thereof and a circular shielding plate which is provided with a slit at its central portion, the reference numeral 1028 indicates a feed motor serving as a power source which rotates the lead screw shaft 1023, the reference numeral 1029 indicates a motor gear mounted to a rotating shaft of the feed motor 1028, the reference numeral 1030 indicates a motor fixing member for holding the feed motor 1028, the reference numeral 1031 indicates a photointerrupter for measuring the number of revolutions of the intermediate gear so as to measure the number of revolutions of the feed motor 1028, the reference numeral 1032 indicates a recording and reproducing mechanism section vertical movement sensing lever for sensing the vertical movement of the recording and reproducing mechanism section 1100 when an optical disk cartridge having the optical disk incorporated thereinto is attached to or detached from the optical disk drive of the present invention, the reference numeral 1033 indicates a guide shaft which regulates and guides the movement of the optical pickup module 1021 to inner and outer circumferential positions of the optical disk, the reference numeral 1034 indicates a guide shaft fixing member for fixing the guide shaft 1033 to the recording and reproducing mechanism main body 1020, the reference numeral 1035 indicates metallic lateral guide members which regulate the vertical movement of the recording and reproducing mechanism main body 1020 and are mounted on both sides, the reference numeral 1036 indicates claw-shaped lateral mooring members which are mounted on both sides and which moor the recording and reproducing mechanism main body 1020, the reference numeral 1037 indicates lateral mooring biasing springs for applying a biasing force in an arbitrary direction to the lateral mooring member 1036 respectively, the reference numeral 1038 indicates recording and reproducing mechanism main body lifting springs including a torsion spring which lift the recording and reproducing mechanism main body 1020, when the optical disk cartridge having the optical disk incorporated therein is attached to or detached from the optical disk drive of the present invention, and the reference numeral 1039 indicate slide buttons fixed to the lateral mooring members 1036.

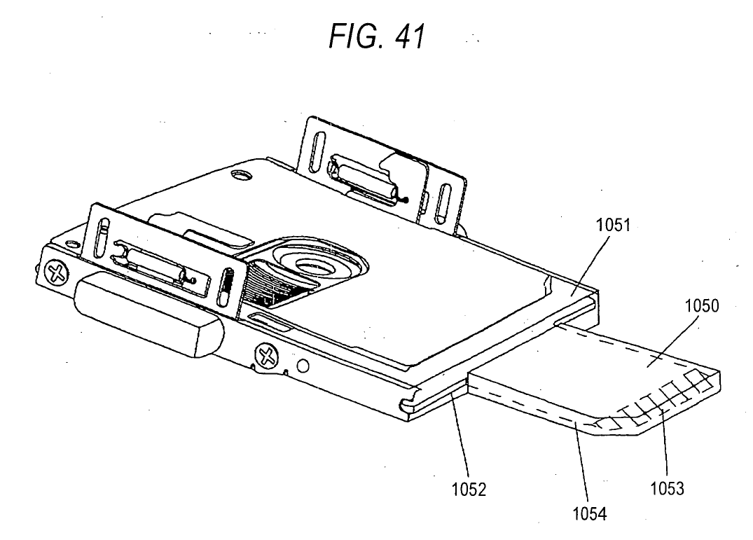

FIG. 41 is a perspective view as the connector section 1101 corresponding to a shape of a semiconductor memory is viewed from the top surface thereof. The reference numeral 1050 indicates a connector unit corresponding to a shape of a semiconductor memory. A board 1052 which has a function to convert a signal from the optical disk into an interface of the semiconductor memory is covered with a resin 1052 from the top, and a main body is reinforced with a metal sheet from the top of the resin 1051.

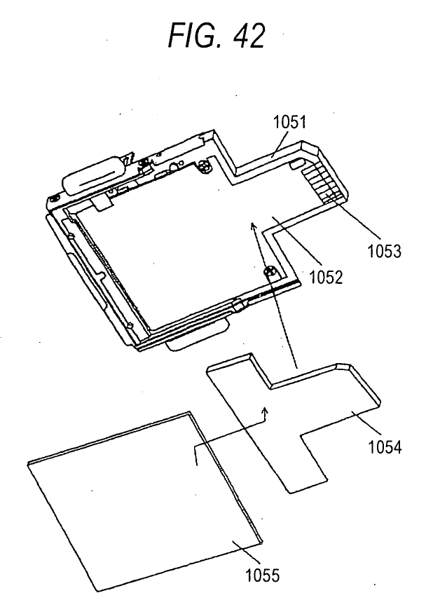

FIG. 42 is a perspective view as the connector unit 1050 is viewed from the bottom surface thereof. The board 1052 has connecting contacts 1053 at its tip. The board 1052 is sandwiched between the resin 1051 from a top surface thereof and a resin 1054 from a bottom surface thereof, and a bottom surface of the resin 1054 is covered with a metal sheet 1055.

In the case of a connector corresponding to the SD standard as one of the embodiments, the size of the connector unit 1050 is 24 mm×32 mm×2.1 mm. As previously mentioned, the connector unit 1050 is sandwiched between the resins, and the resin is interposed between thin metals so as to maintain the rigidity of a portion joined to the main body.

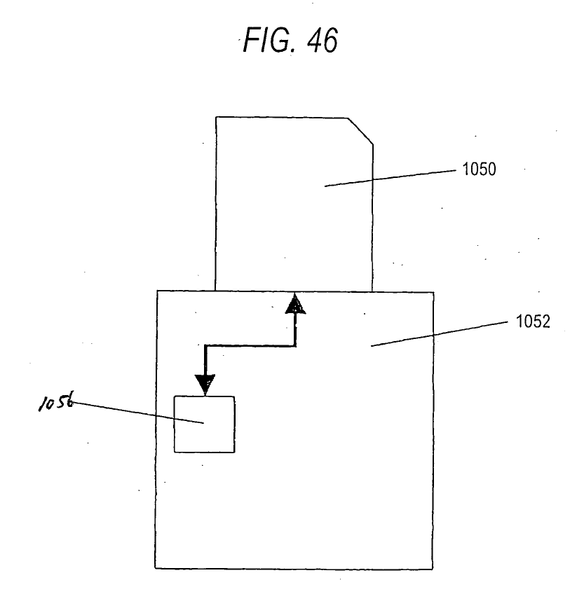

FIG. 46 shows a construction of a top surface of the board 1052. In FIG. 46, the reference numeral 1056 indicate a semiconductor chip for adjusting a connection between an interface standard of the board 1052 and an interface standard of the a connector unit 1050. In the embodiment of the present invention, the semiconductor chip 1056 is configured to be capable of adjusting a connection between the interface standard of the board 1052 and the SD standard of the a connector unit 1050. Also, in other embodiment, the construction of the semiconductor chip 1056 is changed according to a standard. Thus, even if the connector shape of the connector unit 1050 is changed to USB Standard, IEEE394 Standard, a parallel standard, a serial standard and the like, the connector unit can be connected to the board 1052.

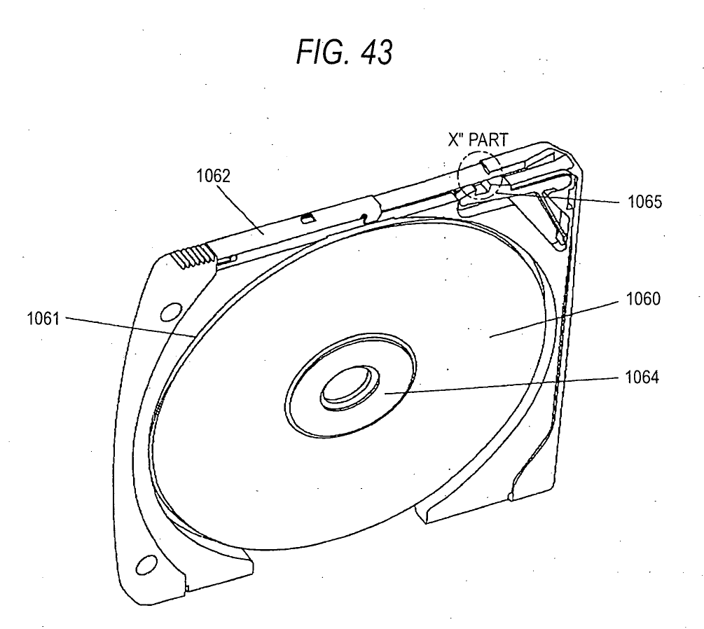

FIG. 43 shows an internal structure of the optical disk cartridge 1061. The reference numeral 1064 indicates a metallic ring which is fixed to the optical disk 1060, and the reference numeral 1065 indicates a shutter mooring member which moors the cartridge shutter 1062.

Next, an operation method and an operation of the information reproducing device (optical disk drive) of the present invention will be described.

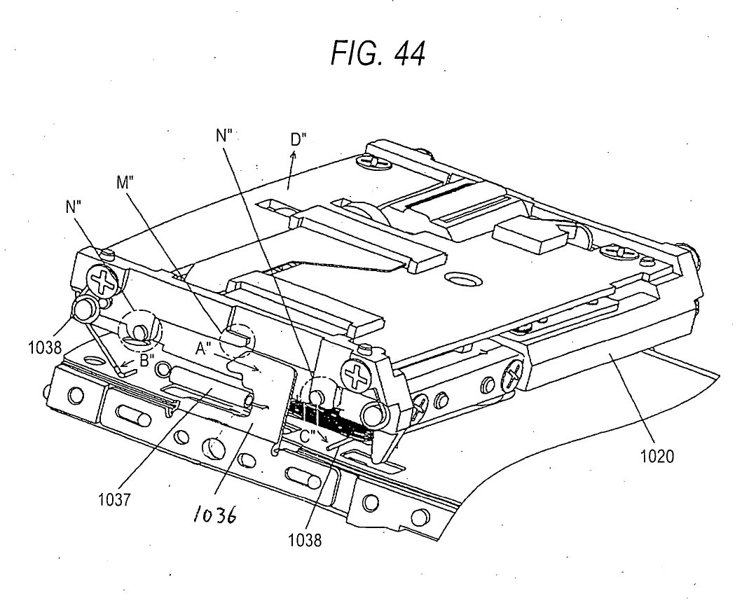

First, when the optical disk cartridge 1061 having the optical disk 1060 accommodated therein is inserted into the base, as shown in FIG. 44, the lateral mooring biasing springs 1037 apply a biasing force to the lateral mooring members 1036 in a direction opposite to the direction that the lateral mooring members 1036 are moved, to thereby move the slide buttons 1039 fixed to the lateral mooring members 1036 toward the a connector unit 1050.

In this case, the slide buttons 1039 are moved toward (direction A″) the connector unit 1050. This operation of the slide buttons 1039 prevent the SD standard connector unit 1050 from falling out of a portable apparatus in a state in which the information reproducing device (optical disc drive) of the present invention is connected to the portable apparatus such as a PDA.

When the slide buttons 1039 are operated toward the connector unit 1050 in the direction A″, convex portions provided on both sides (portions M″) of the recording and reproducing mechanism main body 1020 comes out of the lateral mooring members 1036. Then, the recording and reproducing mechanism main body lifting springs 1038 which are respectively mounted by two, i.e., a total sum of four, on the right and left sides of the recording and reproducing mechanism main body 1020 are opened in directions B″ and C″, to thereby lift the recording and reproducing mechanism main body 1020 in a direction D″. In this case, in the present invention, the recording and reproducing mechanism main body lifting springs 1038 may be a torsion spring or a compression spring.

In this case, in the recording and reproducing mechanism main body 1020, boss-shaped portions (portions N″) provided on both sides of the recording and reproducing mechanism main body 1020 are regulated by grooves provided at the lateral guide members 1035. Thus, as shown in FIG. 40, a raised position of the recording and reproducing mechanism main body 1020 is also regulated. In this case, lower portions of the bossed portions N″ which are provided on both sides of the recording and reproducing mechanism main body 1020 and which move in the grooves provided in the lateral guide members 1035 become points of forces of the recording and reproducing mechanism main body lifting springs 1038. Thus, the recording and reproducing mechanism main body 1020 can be efficiently and smoothly lifted in the vertical direction.

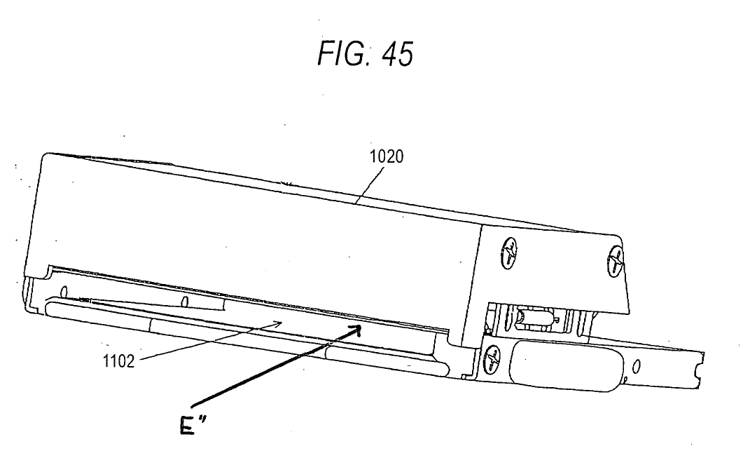

As the recording and reproducing mechanism main body 1020 is raised in the vertical direction, as shown in FIG. 45, an optical disk cartridge insertion slot 1102 appears at a front portion of the connector section 1101. If an operator of the optical disk drive of the present invention inserts the optical disk cartridge 1061 into the insertion slot 1102, the inserted optical disk cartridge 1061 is inserted into the optical disk drive along the cartridge tray. Thereafter, when the operator pushes down with his/her hands in a direction E″, the optical disk is chucked and information is read from the optical disk.

According to the present invention, the present invention can be adapted to an information reproducing device capable of reproducing at least information in which the device can be connected to a portable terminal apparatus such as a portable information apparatus, a cellphone, a portable game machine and the like.

This application is based upon and claims the benefit of priority of Japanese Patent Application No. 2004-003869 filed on Apr. 01, 2009 and Japanese Patent Application No. 2004-190629 filed on Apr. 06, 1929 and Japanese Patent Application No. 2004-193666 filed on Apr. 06, 1930, the contents of which are incorporated herein by references in its entirety.

1. An information reproducing device comprising:
a main body;
a connector unit provided in the main body for establishing an electrical connection with other apparatus;
a medium inserting unit provided in the main body;
a lifting unit which is provided to be freely raised or lowered with respect to the main body and which opens and closes the medium inserting unit;
a reproducing unit held in the lifting unit for reproducing at least information from the medium;
an elastic member for applying a biasing force to the lifting unit and the main body in a direction that the lifting unit and the main body are pulled away from each other;
a locking member for locking the main body and the lifting unit; and
a regulating member for regulating the traveling distance between the main body and the lifting unit,
wherein, in a state in which the main body and the lifting unit are locked by the locking member, the medium inserting unit is closed, and when the locking member is unlocked, the lifting unit is separated from the main body by the elastic member, and the medium inserting unit is opened.

2. The information reproducing device according to claim 1,
wherein the medium is an optical disk, and the reproducing unit is an optical pickup.

3. The information reproducing device according to claim 1,
wherein a plurality of the elastic members is provided at a plurality of places so as to be fixed to the lifting unit.

4. The information reproducing device according to claim 1,
wherein the lifting unit is provided with a cover at least a part of which is made of metal, and the medium inserting unit is opened and closed by a part of the cover.

5. The information reproducing device according to claim 1,
wherein the connector unit is disposed at one end of the main body, the medium inserting unit is disposed at the other end of the main body, and the lifting unit is disposed on one main surface of the main body.

6. An information reproducing device comprising:
a main body;
a connector unit provided in the main body for establishing an electrical connection with a terminal apparatus;
a medium inserting unit provided in the main body for inserting a medium;
a lifting unit which is provided to be freely raised or lowered with a cantilever mechanism having its one axis fixed to the main body and which opens and closes the medium inserting unit; and
a reproducing unit held in the lifting unit for reproducing at least information from the medium,
wherein, while the information reproducing device is connected to the terminal apparatus which controls the information reproducing device, the medium inserting unit is provided at a position where the medium can be replaced from a direction opposite to the direction that the information recording device is connected to the terminal apparatus.

7. An information reproducing device comprising:
a main body;
a connector unit provided in the main body for establishing an electrical connection with a terminal apparatus;
a medium inserting unit provided in the main body for inserting a medium;
a lifting unit which is provided to be freely raised or lowered with a cantilever mechanism having its one axis fixed to the main body and which opens and closes the medium inserting unit; and
a reproducing unit held in the lifting unit for reproducing at least information from the medium,
wherein, while the information reproducing device is connected to the terminal apparatus which controls the information reproducing device, the medium inserting unit is provided at a position where the medium can be replaced from the same direction as the direction that the information reproducing device is connected with the terminal apparatus.

8. An information reproducing device comprising:
a main body;
a connector unit provided in the main body for establishing an electrical connection with a terminal apparatus;
a medium inserting unit provided in the main body for inserting a medium;
a lifting unit which is provided to be freely raised or lowered with a cantilever mechanism having its one axis fixed to the main body and which opens and closes the medium inserting unit; and
a reproducing unit held in the lifting unit for reproducing at least information from the medium,
wherein, while the information reproducing device is connected to the terminal apparatus which controls the information reproducing device, the medium inserting unit is provided at a position where the medium can be replaced from the right with respect to the direction that the information reproducing device is connected with the terminal apparatus.

9. An information reproducing device comprising:
a main body;
a connector unit provided in the main body for establishing an electrical connection with a terminal apparatus;
a medium inserting unit provided in the main body for inserting a medium;
a lifting unit which is provided to be freely raised or lowered with a cantilever mechanism having its one axis fixed to the main body and which opens and closes the medium inserting unit; and
a reproducing unit held in the lifting unit for reproducing at least information from the medium,
wherein, while the information reproducing device is connected to the terminal apparatus which controls the information reproducing device, the medium inserting unit is provided at a position where the medium can be replaced from the left with respect to the direction that the information reproducing device is connected with the terminal apparatus.

10. An information reproducing device comprising:
a main body;
a connector unit provided in the main body for establishing an electrical connection with a terminal apparatus;
a medium inserting unit provided in the main body for inserting a medium;
a lifting unit which is provided to be freely raised or lowered perpendicularly to the main body and which opens and closes the medium inserting unit; and
a reproducing unit held in the lifting unit for reproducing at least information from the medium,
wherein, while the information reproducing device is connected to the terminal apparatus which controls the information reproducing device, the medium inserting unit is provided at a position where the medium can be replaced from a direction opposite to the direction that the information recording device is connected to the terminal apparatus.

11. An information reproducing device comprising:
a main body;
a connector unit provided in the main body for establishing an electrical connection with a terminal apparatus;
a medium inserting unit provided in the main body for inserting a medium;
a lifting unit which is provided to be freely raised or lowered perpendicularly to the main body and which opens and closes the medium inserting unit; and
a reproducing unit held in the lifting unit for reproducing at least information from the medium,
wherein, while the information reproducing device is connected to the terminal apparatus which controls the information reproducing device, the medium inserting unit is provided at a position where the medium can be replaced from the right with respect to the direction that the information reproducing device is connected with the terminal apparatus.

12. An information reproducing device comprising:
a main body;
a connector unit provided in the main body for establishing an electrical connection with a terminal apparatus;
a medium inserting unit provided in the main body for inserting a medium;
a lifting unit which is provided to be freely raised or lowered perpendicularly to the main body and which opens and closes the medium inserting unit; and
a reproducing unit held in the lifting unit for reproducing at least information from the medium,
wherein, while the information reproducing device is connected to the terminal apparatus which controls the information reproducing device, the medium inserting unit is provided at a position where the medium can be replaced from the left with respect to the direction that the information reproducing device is connected with the terminal apparatus.

13. An information reproducing device comprising:
an insertion slot into which an optical disk is inserted;
a lifting unit which opens and closes the insertion slot;
a reproducing unit held in the lifting unit for reproducing at least information from the optical disk;
an electronic board which converts an optical signal output from the reproducing unit into an electrical signal; and
a connector unit which establishes an electrical connection with other apparatus.

14. An information reproducing apparatus comprising:
a main body;
a connector unit provided in the main body for establishing an electrical connection with other apparatus;
a medium inserting unit provided in the main body; and
a reproducing unit for reproducing at least information from the medium, wherein, in a state in which the connector unit is connected with the other device, the medium is detachable from the medium inserting unit.
